(19) United States
(12) Patent Application Publication
(10) Pub. No.: US 2004/0106534 A1
(43) Pub. Date: Jun. 3, 2004

(54) Dishwasher agent with additional uses

(76) Inventors: Christian Nitsch, Duesseldorf (DE); Bernd Richter, Leichlingen (DE); Rolf Bayersdoerfer, Duesseldorf (DE); Thomas Holderbaum, Monheim (DE); Matthias Sunder, Duesseldorf (DE); Arnd Kessler, Leverkusen (DE); Rainer Sorg, Dormagen (DE); Peter Schmiedel, Duesseldorf (DE); Maren Jekel, Duesseldorf (DE); Ulrich Pegelow, Duesseldorf (DE); Harald Volk, Mondercange (DE); Manfred Greger, Schifflange (DE); Markus Schlienz, Trier (DE)

Correspondence Address: HENKEL CORPORATION, THE TRIAD, SUITE 200, 2200 RENAISSANCE BLVD., GULPH MILLS, PA, 19406, US

(21) Appl. No.: 10/332,332

(22) PCT Filed: Jun. 27, 2001
(86) PCT No.: PCT/EP01/07334

(30) Foreign Application Priority Data
Jul. 7, 2000 (DE) 100326110

(51) Int. Cl. C11D 1/00

(52) U.S. Cl. 510/220; 510/475

(57) ABSTRACT

The invention relates to a cleaning agent for dishwashers comprising a first part (basic composition), which mainly acts during the main cleaning cycle of the dishwasher, and a second part, which mainly acts during the rinsing cycle of the dishwasher as a result a suitable coating. The second part contains one or several substances form the following group: detergency builders, acidifying agents, chelate complex builders or coating inhibiting polymers.

The present invention relates to detergents, especially machine dishwashing detergents with controlled release of active substance. The present invention relates in particular to machine dishwashing detergents possessing a system which allows controlled release of at least one active substance in the washing operation and at least one active substance in the aftertreatment operation. The invention also relates to a process for producing such machine dishwashing detergents. The invention also relates to washing methods using said machine dishwashing detergents.

For a long time it was common practice to provide the consumer with detergents in the form of bulk-packaged product and to leave it up to the user, at the time of use, to dose the detergent in accordance with the applicational requirements, which depended on the water hardness, the nature and or amount of the ware to be cleaned and/or its degree of soiling, the amount of the wash liquor, and other parameters too.

With a view to the desire on the part of the consumer to obtain detergents which were easier and more convenient to dose, these detergents have increasingly been provided in a form which renders ad hoc dosing superfluous: detergents have been formulated in measured portions containing all of the components necessary for one wash. In the case of solid products, portions of this kind have frequently been formed into shaped bodies (sometimes comprising two or more phases) such as granules, beads, tablets (“tabs”), blocks, briquettes, etc., which are dosed as a whole into the liquor. Liquid products have been introduced into water-soluble envelopes which dissolve on contact with the aqueous liquor and release their contents into the liquor.

A disadvantage of these solutions is that all of the components needed in the course of a wash pass into the aqueous liquor simultaneously. Not only does this give rise to problems of incompatibility of certain components of a detergent with other components but it also becomes impossible to dose particular components into the liquor in a targeted way, at a defined point in time.

In the meantime, the prior art has described ways in which individual detergent components can be dosed in a targeted manner and at a defined point in time during the application. For example, temperature-controlled active substance release is described, which allows active substances such as surfactants, bleaches, soil release polymers, and the like to be released either in the wash cycle or even in the aftertreatment cycle—for example, in the rinse cycle in the case of machine dishwashing. Corresponding products with integrated rinse aid are now available commercially.

These “2 in 1” products, as they are known, simplify handling and relieve the consumer of the burden of additional dosing of two different products (detergent and rinse aid). Nevertheless, at intervals of time, the operation of a household dishwasher requires two dosing operations, since after a certain number of washes it is necessary to top up the regenerating salt in the machine's water softening system. These water softening systems consist of ion exchange polymers, which soften the hard water flowing into the machine and, following the wash program, are regenerated by flushing with salt water.

The object on which the present invention was based, then, was to provide a product which only has to be dosed once per application without the need for the dosing of another product, and hence a two-fold dosing operation, even after a relatively high number of wash cycles. The intention was to provide a product which in addition to the “built-in rinse aid” makes it unnecessary to top up the regenerating salt container and so further simplifies handling. The performance of the product ought to match or exceed the performance level of conventional three-product systems (salt-detergent-rinse aid) and of innovative two-product systems (“2 in 1” detergent-rinse aid).

It has now been found that the addition of regenerating salt to household dishwashers is unnecessary if compounds from certain classes of substance are introduced into the rinse cycle.

The present invention provides detergents for machine dishwashing, comprising

a) a first part (base composition), which exerts its effect substantially in the main wash cycle of the dishwasher; and

b) a second part, which by dint of appropriate coating develops its effect substantially in the rinse cycle of the dishwasher,

wherein the second part comprises one or more substances selected from the group consisting of builders, acidifiers, chelating agents, and scale inhibiting polymers.

These substances, whose use in the rinse cycle has not been described in the prior art, result in rinse cycles being implementable with mains water of normal hardness rather than with softened water, with no loss of performance. Said groups include substances of which some are particularly suitable in the context of the present invention. These are described below.

The most important ingredients of machine dishwashing detergents are builders. The second part of the machine dishwashing detergents of the invention may comprise all of the builders commonly used in detergents, i.e., in particular, zeolites, silicates, carbonates, organic cobuilders, and phosphates.

Suitable crystalline, sheetlike sodium silicates possess the general formula NaMSiₓO₂ₓ₊₁.H₂O, where M is sodium or hydrogen, x is a number from 1.9 to 4, y is a number from 0 to 20, and preferred values for x are 2, 3 or 4. Preferred crystalline phyllosilicates of the formula indicated are those in which M is sodium and x adopts the value 2 or 3. In particular, both β- and δ-sodium disilicates Na₂Si₂O₅.yH₂O are preferred.

It is also possible to use amorphous sodium silicates having an Na₂O:SiO₂ modulus of from 1:2 to 1:3.3, preferably from 1:2 to 1:2.8, and in particular from 1:2 to 1:2.6, which are dissolution-retarded. The retardation of dissolution relative to conventional amorphous sodium silicates may have been brought about in a variety of ways—for example, by surface treatment, compounding, compacting, or overdrying. In the context of this invention, the term “amorphous” also embraces “X-ray-amorphous”. This means that in X-ray diffraction experiments the silicates do not yield the sharp X-ray reflections typical of crystalline substances but instead yield at best one or more maxima of the scattered X-radiation, having a width of several degree units of the diffraction angle. However, even particularly good builder properties may well result if the silicate particles in electron diffraction experiments yield vague or even sharp diffraction maxima. The interpretation of this is that the products have microcrystalline regions with a size of from 10 to several hundred nm, values up to max. 50 nm and in particular up to max. 20 nm being preferred. Such X-ray-amorphous silicates, as they are known, likewise have a retardation of dissolution relative to the conventional waterglasses. Particular preference is given to compacted amorphous silicates, compounded amorphous silicates, and overdried X-ray-amorphous silicates.

The finely crystalline, synthetic zeolite used, containing bound water, is preferably zeolite A and/or P. A particularly preferred zeolite P is Zeolite MAP® (commercial product from Crosfield). Also suitable, however, are zeolite X and also mixtures of A, X and/or P. Another product available commercially and able to be used with preference in the context of the present invention, for example, is a cocrystallizate of zeolite X and zeolite A (approximately 80% by weight zeolite X), which is sold by CONDEA Augusta S.p.A. under the brand name VEGOBOND AX® and may be described by the formula

nNa₂O.(1−n)K₂O.Al₂O₃.(2-2.5)SiO₂.(3.5-5.5)H₂O.

Suitable zeolites have an average particle size of less than 10 μm (volume distribution; measurement method: Coulter counter) and contain preferably from 18 to 22% by weight, in particular from 20 to 22% by weight, of bound water.

Of course, the widely known phosphates may also be used as builder substances provided such a use is not to be avoided on ecological grounds. Among the large number of commercially available phosphates, the alkali metal phosphates, with particular preference being given to pentasodium and pentapotassium triphosphate (sodium and potassium tripolyphosphate, respectively), possess the greatest importance in the detergents industry.

Alkali metal phosphates is the collective term for the alkali metal (especially sodium and potassium) salts of the various phosphoric acids, among which meta-phosphoric acids (HPO₃)ₙ and orthophosphoric acid H₃PO₄, in addition to higher-molecular-mass representatives, may be distinguished. The phosphates combine a number of advantages: they act as alkali carriers, prevent limescale deposits on machine components and lime encrustations in fabrics, and additionally contribute to cleaning performance.

Sodium dihydrogen phosphate, NaH₂PO₄, exists as the dihydrate (density 1.91 g cm⁻³, melting point 600) and as the monohydrate (density 2.04 g cm⁻³). Both salts are white powders of very ready solubility in water which lose the water of crystallization on heating and undergo conversion at 200° C. into the weakly acidic diphosphate (disodium hydrogen diphosphate, Na₂H₂P₂O₇) and at a higher temperature into sodium trimeta-phosphate (Na₃P₃O₉) and Maddrell's salt (see below). NaH₂PO₄ reacts acidically; it is formed if phosphoric acid is adjusted to a pH of 4.5 using sodium hydroxide solution and the slurry is sprayed. Potassium dihydrogen phosphate (primary or monobasic potassium phosphate, potassium biphosphate, PDP), KH₂PO₄, is a white salt with a density of 2.33 g cm⁻³, has a melting point of 253° [decomposition with formation of potassium polyphosphate (KPO₃)ₓ], and is readily soluble in water.

Disodium hydrogen phosphate (secondary sodium phosphate), Na₂HPO₄, is a colorless, crystalline salt which is very readily soluble in water. It exists in anhydrous form and with 2 mol (density 2.066 g cm³, water loss at 95°), 7 mol (density 1.68 g cm³, melting point 48° with loss of 5H₂O), and 12 mol (density 1.52 g cm⁻³, melting point 35° with loss of 5H₂O) of water, becomes anhydrous at 100°, and if heated more intensely undergoes transition to the diphosphate Na₄P₂O₇. Disodium hydrogen phosphate is prepared by neutralizing phosphoric acid with sodium carbonate solution using phenolphthalein as indicator. Dipotassium hydrogen phosphate (secondary or dibasic potassium phosphate), K₂HPO₄, is an amorphous white salt which is readily soluble in water.

Trisodium phosphate, tertiary sodium phosphate, Na₃PO₄, exists as colorless crystals which as the dodecahydrate have a density of 1.62 g cm⁻³ and a melting point of 73-76° C. (decomposition), as the decahydrate (corresponding to 19-20% P₂O₅) have a melting point of 100° C., and in anhydrous form (corresponding to 39-40% P₂O₅) have a density of 2.536 g cm³. Trisodium phosphate is readily soluble in water, with an alkaline reaction, and is prepared by evaporative concentration of a solution of precisely 1 mol of disodium phosphate and 1 mol of NaOH. Tripotassium phosphate (tertiary or tribasic potassium phosphate), K₃PO₄, is a white, deliquescent, granular powder of density 2.56 g cm⁻³, has a melting point of 1340°, and is readily soluble in water with an alkaline reaction. It is produced, for example, when Thomas slag is heated with charcoal and potassium sulfate. Despite the relatively high price, the more readily soluble and therefore highly active potassium phosphates are frequently preferred in the detergents industry over the corresponding sodium compounds.

Tetrasodium diphosphate (sodium pyrophosphate), Na₄P₂O₇, exists in anhydrous form (density 2.534 g cm⁻³, melting point 988°, 880° also reported) and as the decahydrate (density 1.815-1.836 g cm³, melting point 940 with loss of water). Both substances are colorless crystals which dissolve in water with an alkaline reaction. Na₄P₂O₇ is formed when disodium phosphate is heated to >200° or by reacting phosphoric acid with sodium carbonate in stoichiometric ratio and dewatering the solution by spraying. The decahydrate complexes heavy metal salts and water hardeners and therefore reduces the hardness of the water. Potassium diphosphate (potassium pyrophosphate), K₄P₂O₇, exists in the form of the trihydrate and is a colorless, hygroscopic powder of density 2.33 g cm⁻³ which is soluble in water, the pH of the 1% strength solution at 250 being 10.4.

Condensation of NaH₂PO₄ or of KH₂PO₄ gives rise to higher-molecular-mass sodium and potassium phosphates, among which it is possible to distinguish cyclic representatives, the sodium and potassium metaphosphates, and catenated types, the sodium and potassium polyphosphates. For the latter in particular a large number of names are in use: fused or calcined phosphates, Graham's salt, Kurrol's and Maddrell's salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6 H₂O and has the general formula NaO—[P(O)(ONa)—O]ₙ—Na where n=3. About 17 g of the anhydrous salt dissolve in 100 g of water at room temperature, about 20 g at 60°, around 32 g at 100°; after heating the solution at 100° C. for two hours, about 8% orthophosphate and 15% diphosphate are produced by hydrolysis. For the preparation of pentasodium triphosphate, phosphoric acid is reacted with sodium carbonate solution or sodium hydroxide solution in stoichiometric ratio and the solution is dewatered by spraying. In a similar way to Graham's salt and sodium diphosphate, pentasodium triphosphate dissolves numerous insoluble metal compounds (including lime soaps, etc.). Pentapotassium triphosphate, K₅P₃O₁₀ (potassium tripolyphosphate), is commercialized, for example, in the form of a 50% strength by weight solution (>23% P₂O₅, 25% K₂O). The potassium polyphosphates find broad application in the detergents industry. There also exist sodium potassium tripoly-phosphates, which may likewise be used for the purposes of the present invention. These are formed, for example, when sodium trimetaphosphate is hydrolyzed with KOH:

(NaPO₃)₃+2KOH→Na₃K₂P₃O₁₀+H₂O

They can be used in accordance with the invention in precisely the same way as sodium tripolyphosphate, potassium tripolyphosphate, or mixtures of these two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphospate, may also be used in accordance with the invention.

Further suitable builders are carbonates, hydrogen carbonates, and the salts of oligocarboxylic acids, for example, gluconates, succinates, and citrates in particular. Detergents of the invention wherein the second part contains one or more builders from the group consisting of sodium carbonate, sodium hydrogen carbonate, and trisodium citrate in amounts above 10% by weight, preferably above 15% by weight, with particular preference above 20% by weight, and in particular above 25% by weight, based in each case on the weight of the second part, are preferred in accordance with the invention.

In the context of the present invention, acidifiers are likewise suitable as ingredients for the second part. Examples of substances from this group are boric acid and also alkali metal hydrogen sulfates, alkali metal dihydrogen phosphates, and other inorganic salts can be used. It is preferred, however, to use organic acidifiers, with citric acid being a particularly preferred acidifier. It is also possible, however, to make use in particular of the other solid monocarboxylic, oligocarboxylic, and polycarboxylic acids. Preferred in turn from this group are tartaric acid, succinic acid, malonic acid, adipic acid, maleic acid, fumaric acid, oxalic acid, and polyacrylic acid.

Organic sulfonic acids such as amidosulfonic acid can likewise be used. A commercially available product which can likewise be used with preference as an acidifier in the context of the present invention is Sokalan® DCS (trademark of BASF), a mixture of succinic acid (max. 31% by weight), glutaric acid (max. 50% by weight), and adipic acid (max. 33% by weight). Particularly preferred detergents of the invention are characterized in that the second part contains one or more acidifiers from the group consisting of citric acid, adipic acid, malic acid, fumaric acid, maleic acid, malonic acid, oxalic acid, succinic acid, and tartaric acid in amounts above 5% by weight, preferably above 10% by weight, with particular preference above 20% by weight, and in particular above 25% by weight, based in each case on the weight of the second part.

A further possible group of ingredients for the second part are the chelating agents. Chelating agents are substances which form cyclic compounds with metal ions, with a single ligand occupying more than one coordination site on a central atom, i.e., being at least “bidentate”. In this case, therefore, normally extended compounds are ring-closed by complexing via an ion. The number of attached ligands depends on the coordination number of the central ion.

Chelating agents which are common and preferred in the context of the present invention are, for example, polyoxycarboxylic acids, polyamines, ethylenediaminetetraacetic acid (EDTA), and nitrilotriacetic acid (NTA). Complexing polymers as well, i.e., polymers which either in the main chain itself or pendantly thereto carry functional groups which can act as ligands and which generally react with suitable metal atoms to form chelate complexes, can be used in accordance with the invention. The polymer-attached ligands of the resulting metal complexes may originate from only one macromolecule or else may belong to different polymer chains. The latter leads to crosslinking of the material, provided the complex-forming polymers were not already crosslinked beforehand by way of covalent bonds.

Complexing groups (ligands) of common complex-forming polymers are iminodiacetic acid, hydroxyquinoline, thiourea, guanidine, dithiocarbamate, hydroxamic acid, amide oxime, aminophosphoric acid, (cyclic) polyamino, mercapto, 1,3-dicarbonyl, and crown ether radicals having in some cases highly specific activities toward ions of different metals. Base polymers of many complexing polymers, including commercially significant ones, are polystyrene, polyacrylates, polyacrylo-nitriles, polyvinyl alcohols, polyvinylpyridines, and polyethyleneimines. Natural polymers as well, such as cellulose, starch or chitin, are complex-forming polymers. Furthermore, they can be provided with additional ligand functionalities by means of polymer-analogous transformations.

Particular preference is given in the context of the present invention to detergents wherein the second part contains one or more chelating agents from the groups consisting of

(i) polycarboxylic acids wherein the sum of the carboxyl and any hydroxyl groups is at least 5,

(ii) nitrogen-containing monocarboxylic or poly-carboxylic acids,

(iii) geminal diphosphonic acids,

(iv) aminophosphonic acids,

(v) phosphonopolycarboxylic acids, and

(vi) cyclodextrins

in amounts above 0.1% by weight, preferably above 0.5% by weight, with particular preference above 1% by weight, and in particular above 2.5% by weight, based in each case on the weight of the second part.

In the context of the present invention it is possible to use all prior art complexing agents. These may belong to different chemical groups. Preference is given to using the following, individually or in a mixture with one another:

a) polycarboxylic acids wherein the sum of the carboxyl and any hydroxyl groups is at least 5, such as gluconic acid,

b) nitrogen-containing monocarboxylic or poly-carboxylic acids, such as ethylenediaminetetra-acetic acid (EDTA), N-hydroxyethylethylenediamine-triacetic acid, diethylenetriaminepentaacetic acid, hydroxyethyliminodiacetic acid, nitrido-diacetic acid-3-propionic acid, isoserinediacetic acid, N,N-di(β-hydroxyethyl)glycine, N-(1,2-di-carboxy-2-hydroxyethyl)glycine, N-(1,2-dicarboxy-2-hydroxyethyl)aspartic acid or nitrilotriacetic acid (NTA),

c) geminal diphosphonic acids, such as 1-hydroxy-ethane-1,1-diphosphonic acid (HEDP), higher homologs thereof having up to 8 carbon atoms, and also hydroxyl- or amino-containing derivatives thereof, and 1-aminoethane-1,1-diphosphonic acid, higher homologs thereof having up to 8 carbon atoms, and also hydroxyl- or amino-containing derivatives thereof,

d) aminophosphonic acids such as ethylenediamine-tetra(methylenephosphonic acid), diethylenetriaminepenta(methylenephosphonic acid) or nitrilotri(methylenephosphonic acid),

e) phosphonopolycarboxylic acids, such as 2-phosphonobutane-1,2,4-tricarboxylic acid, and

f) cyclodextrins.

Polycarboxylic acids a) in the context of this patent application are understood to be carboxylic acids—including monocarboxylic acids—wherein the sum of carboxyl groups and the hydroxyl groups present in the molecule is at least 5. Complexing agents from the group of the nitrogen-containing polycarboxylic acids, especially EDTA, are preferred. At the alkaline pH values of the treatment solutions, which are required in accordance with the invention, these complexing agents are present at least partly in the form of anions. It is uncritical whether they are introduced in the form of the acids or in the form of salts. When used as salts, preference is given to alkali metal, ammonium or alkylammonium salts, especially sodium salts.

In the case of the scale inhibiting polymers as ingredients of the second part, particular preference is given to detergents characterized in that the second part contains one or more scale inhibiting polymers from the group consisting of cationic homopolymers or copolymers, especially hydroxypropyltrimethylammoniumguar; copolymers of aminoethyl methacrylate and acrylamide, copolymers of dimethyldiallylammonium chloride and acrylamide, polymers containing imino groups, polymers containing quaternized ammonium-alkyl methacrylate groups as monomer units, cationic polymers of monomers such as trialkylammonium-alkyl (meth)acrylate or -acrylamide; dialkyldiallyldiammonium salts; polymer-analogous reaction products of ethers or esters of polysaccharides with ammonium side groups, especially guar derivatives, cellulose derivatives, and starch derivatives; polyadducts of ethylene oxide with ammonium groups; quaternary ethyleneimine polymers and polyesters and polyamides having quaternary side groups in amounts above 5% by weight, preferably above 10% by weight, with particular preference above 20% by weight, and in particular above 25% by weight, based in each case on the weight of the second part.

A further preferred ingredient for the second part is represented by certain copolymers containing sulfonic acid groups. Thus detergents whose second part contains one or more copolymers of

i) unsaturated carboxylic acids

ii) monomers containing sulfonic acid groups

iii) if desired, further ionic or nonionogenic monomers

in amounts above 5% by weight, preferably above 10% by weight, with particular preference above 20% by weight, and in particular above 25% by weight, based in each case on the weight of the second part, are also preferred embodiments of the present invention.

In the context of the present invention, preference as monomer is given to unsaturated carboxylic acids of the formula I

R¹(R²)C═C(R³)COOH (I),

in which R¹ to R³ independently of one another stand for —H—CH₃, a straight-chain or branched saturated alkyl radical having from 2 to 12 carbon atoms, a straight-chain or branched mono- or polyunsaturated alkenyl radical having from 2 to 12 carbon atoms, H₂N—, HO— or HOOC-substituted alkyl or alkenyl radicals as defined above, or for —COOH or —COOR⁴, with R⁴ being a saturated or unsaturated, straight-chain or branched hydrocarbon radical having from 1 to 12 carbon atoms.

Among the unsaturated carboxylic acids which can be described by the formula I, particular preference is given to acrylic acid (R¹═R², R³H), methacrylic acid (R¹═R²=H; R³═CH₃) and/or maleic acid (R¹═COOH; R²═R³═H).

Among the monomers containing sulfonic acid groups, preference is given to those of the formula II

R⁵ (R⁶)C═C(R⁷)—X—SO₃H (II),

in which R⁵ to R⁷ independently of one another stand for —H—CH₃, a straight-chain or branched saturated alkyl radical having from 2 to 12 carbon atoms, a straight-chain or branched mono- or polyunsaturated alkenyl radical having from 2 to 12 carbon atoms, H₂N—, HO— or HOOC-substituted alkyl or alkenyl radicals as defined above or for —COOH or —COOR⁴, R⁴ being a saturated or unsaturated, straight-chain or branched hydrocarbon radical having from 1 to 12 carbon atoms, and X stands for a spacer group which is present optionally and is selected from —(CH₂)ₙ— where n=0 to 4, —COO—(CH₂)ₖ— where k=1 to 6, —C(O)—NH—C(CH₃)₂— and —C(O)—NH—CH(CH₂CH₃)—.

Of these monomers, preference is given to those of the formulae IIa, IIb and/or IIc

H₂C═CH—X—SO₃H (IIa),

H₂C═C(CH₃)—X—SO₃H (IIb),

HO₃S—X—(R⁶)C═C(R⁷)—X—SO₃H (IIc),

in which R⁶ and R⁷ are selected independently of one another from —H, —CH₃, —CH₂CH₃, —CH₂CH₂CH₃, —CH(CH₃)₂, and X stands for a spacer group, which is present optionally and is selected from —(CH₂)ₙ— where n=0 to 4, —COO—(CH₂)ₖ— where k=1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid (X≡C(O)NH—CH(CH₂CH₃) in formula IIa), 2-acrylamido-2-propanesulfonic acid (X≡C(O)NH—C(CH₃)₂ in formula IIa), 2-acrylamido-2-methyl-1-propanesulfonic acid (X=—C(O)NH—CH(CH₃)CH₂— in formula IIa), 2-methacrylamido-2-methyl-1-propanesulfonic acid (X=—C(O)NH—CH(CH₃)CH₂— in formula IIb), 3-methacrylamido-2-hydroxypropane-sulfonic acid (X=—C(O)NH—CH₂CH(OH)CH₂— in formula IIb), allylsulfonic acid (X═CH₂ in formula IIa) methallylsulfonic acid (X═CH₂ in formula IIb), allyloxybenzenesulfonic acid (X=—CH₂—O—C₆H₄— in formula IIa), methallyloxybenzenesulfonic acid (X=—CH₂—O—C₆H₄— in formula IIb), 2-hydroxy-3-(2-propenyloxy)propanesulfonic acid, 2-methyl-2-propene-1-sulfonic acid (X═CH₂ in formula IIb), styrenesulfonic acid (X═C₆H₄ in formula IIa), vinylsulfonic acid (X not present in formula IIa), 3-sulfopropyl acrylate (X=—C(O)NH—CH₂CH₂CH₂— in formula IIa), 3-sulfopropylmethacrylate (X=—C(O)NH—CH₂CH₂CH₂— in formula IIb), sulfomethacrylamide (X=—C(O)NH— in formula IIb), sulfomethylmethacrylamide (X=—C(O)NH—CH₂— in formula IIb), and water-soluble salts of said acids.

As further ionic or nonionogenic monomers, ethylenically unsaturated compounds are especially suitable. The amount of monomers of group iii) in the polymers used in accordance with the invention is preferably less than 20% by weight, based on the polymer. With particular preference, polymers present in the second part consist solely of monomers of groups i) and ii).

Particularly preferred detergents comprise in the second part one or more copolymers of

i) one or more unsaturated carboxylic acids from the group consisting of acrylic acid, methacrylic acid and/or maleic acid

ii) one or more monomers containing sulfonic acid groups, of the formulae IIa, IIb and/or IIc

H₂O═CH—X—SO₃H (IIa),

H₂C═C(CH₃)—X—SO₃H (IIb),

HO₃S—X—(R⁶)C═C(R⁷)—X—SO₃H (IIc),

in which R⁶ and R⁷ are selected independently of one another from —H, —CH₃, —CH₂CH₃, —CH₂CH₂CH₃, —CH(CH₃)₂, and X stands for a spacer group, which is present optionally and is selected from —(CH₂)ₙ— where n=0 to 4, —COO—(CH₂)ₖ— where k=1 to 6, —C(O)—NH—C(CH₃)₂— and —C(O)—NH—CH(CH₂CH₃)—

iii) if desired, further ionic or nonionogenic monomers.

The copolymers present in the second part may contain the monomers from groups i) and ii) and also, where appropriate, iii) in varying amounts, it being possible to combine all representatives from group i) with all representatives from group ii) and all representatives from group iii). Particularly preferred polymers exhibit particular structural units, which are described below.

Preference is thus given, for example, to a D of the invention which is characterized in that the second part comprises one or more copolymers containing structural units of the formula III

—[CH₂—CHCOOH]ₘ—[CH₂—CHC(O)—Y—SO₃H]ₚ— (III)

in which m and p each stand for a whole natural number between 1 and 2000 and Y stands for a spacer group which is selected from substituted or unsubstituted aliphatic, aromatic or araliphatic hydrocarbon radicals having from 1 to 24 carbon atoms, preference being given to spacer groups in which Y stands for —O—(CH₂)ₙ— with n=0 to 4, for —O—(C₆H₄)—, for —NH—C(CH₃)₂— or —NH—CH(CH₂CH₃)—.

These polymers are prepared by copolymerizing acrylic acid with an acrylic acid derivative containing sulfonic acid groups. If the acrylic acid derivative containing sulfonic acid groups is copolymerized with methacrylic acid, a different polymer is obtained, whose use is likewise preferred in the second part of the detergents of the invention and is characterized in that one or more copolymers are used which contain structural units of the formula IV

—[CH₂—C(CH₃)COOH]ₘ—[CH₂—CHC(O)—Y—SO₃H]ₚ— (IV),

in which m and p each stand for a whole natural number between 1 and 2000 and Y stands for a spacer group which is selected from substituted or unsubstituted aliphatic, aromatic or araliphatic hydrocarbon radicals having from 1 to 24 carbon atoms, preference being given to spacer groups in which Y stands for —O—(CH₂)ₙ— with n=0 to 4, for —O—(C₆H₄)—, for —NH—C(CH₃)₂— or —NH—CH(CH₂CH₃)—.

Entirely analogously, acrylic acid and/or methacrylic acid can also be copolymerized with methacrylic acid derivatives containing sulfonic acid groups, thereby changing the structural units in the molecule. Preference is therefore given to detergents of the invention whose second part comprises one or more copolymers containing structural units of the formula V

—[CH₂—CHCOOH]ₘ—[CH₂—C(CH₃)C(O)—Y—SO₃H]ₚ— (V),

in which m and p each stand for a whole natural number between 1 and 2000, and Y stands for a spacer group which is selected from substituted or unsubstituted aliphatic, aromatic or araliphatic hydrocarbon radicals having from 1 to 24 carbon atoms, preference being given to spacer groups in which Y stands for —O—(CH₂)ₙ— with n=0 to 4, for —O—(C₆H₄)—, for —NH—C(CH₃)₂— or —NH—CH(CH₂CH₃)—, likewise a preferred embodiment of the present invention, in just the same way as preference is also given to detergents which are characterized in that the second part comprises one or more copolymers containing structural units of the formula VI

—[CH₂—C(CH₃)COOH]ₘ—[CH₂—C(CH₃)C(O) Y—SO₃H]ₚ— (VI),

in which m and p each stand for a whole natural number between 1 and 2000 and Y stands for a spacer group which is selected from substituted or unsubstituted aliphatic, aromatic or araliphatic hydrocarbon radicals having from 1 to 24 carbon atoms, preference being given to spacer groups in which Y stands for —O—(CH₂)ₙ— with n=0 to 4, for —O—(C₆H₄)—, for —NH—C(CH₃)₂— or —NH—CH(CH₂CH₃)—.

Instead of acrylic acid and/or methacrylic acid or in addition thereto it is also possible to use maleic acid as a particularly preferred monomer from group i). In this way, inventively preferred detergents are obtained which are characterized in that the second part comprises one or more copolymers containing structural units of the formula VII

—[HOOCCH—CHCOOH]ₘ—CH₂—CHC(O)—Y—SO₃H]ₚ— (VII),

in which m and p each stand for a whole natural number between 1 and 2000 and Y stands for a spacer group which is selected from substituted or unsubstituted aliphatic, aromatic or araliphatic hydrocarbon radicals having from 1 to 24 carbon atoms, preference being given to spacer groups in which Y stands for —O—(CH₂)ₙ— with n=0 to 4, for —O—(C₆H₄)—, for —NH—C(CH₃)₂— or —NH—CH(CH₂CH₃)—, and detergents are obtained which are characterized in that the second part comprises one or more copolymers containing structural units of the formula VIII

—[HOOCCH—CHCOOH]ₘ—[CH₂—C(CH₃)C(O)O—Y—SO₃H]ₚ— (VIII),

in which m and p each stand for a whole natural number between 1 and 2000 and Y stands for a spacer group which is selected from substituted or unsubstituted aliphatic, aromatic or araliphatic hydrocarbon radicals having from 1 to 24 carbon atoms, preference being given to spacer groups in which Y stands for —O—(CH₂)ₙ— with n=0 to 4, for —O— (C₆H₄)—, for —NH—C(CH₃)₂— or —NH—CH(CH₂CH₃)—.

Within the polymers the sulfonic acid groups may be present wholly or partly in neutralized form, i.e., the acidic hydrogen atom of the sulfonic acid group in some or all sulfonic acid groups may have been exchanged for metal ions, preferably alkali metal ions, and in particular for sodium ions. Corresponding detergents which are characterized in that the sulfonic acid groups in the copolymer are present in partly or fully neutralized form are preferred in accordance with the invention.

For copolymers containing only monomers from groups i) and ii), the monomer distribution in the copolymers present in accordance with the invention in the second part is preferably in each case from 5 to 95% by weight of i) and/or ii), with particular preference from 50 to 90% by weight of monomer from group i) and from 10 to 50% by weight of monomer from group ii), based in each case on the polymer.

In the case of terpolymers, particular preference is given to those containing from 20 to 85% by weight of monomer from group i), from 10 to 60% by weight of monomer from group ii), and from 5 to 30% by weight of monomer from group iii).

The molar mass of the polymers present in accordance with the invention in the second part can be varied in order to adapt the properties of the polymers to the desired end use. Preferred detergents are characterized in that the copolymers have molar masses of from 2000 to 200 000 g/mol⁻¹, preferably from 4000 to 25 000 g/mol⁻¹, and in particular from 5000 to 15 000 g/mol⁻¹.

In addition to the additional benefit of being able to dispense with the dosing of regenerating salt, the products of the invention also render the additional dosing of a rinse aid superfluous. The clear-rinse effect can be improved markedly if the detergents of the invention comprise surfactants, especially nonionic surfactants. The surfactants may on the one hand be present in the first part (the “base composition”) and pass into the rinse cycle by way of liquor entrainment or other phenomena, and on the other hand may also be a component of the second part, which as a result of the coating does not substantially develop its effect until the rinse cycle of the dishwasher.

In the context of the present invention preference is given here to detergents wherein the second part contains additionally from 1 to 50% by weight, preferably from 2.5 to 45% by weight, and in particular from 5 to 40% by weight of nonionic surfactant(s), the amounts by weight being based on the second part including coating.

Nonionic surfactants used are preferably alkoxylated, advantageously ethoxylated, especially primary, alcohols having preferably 8 to 18 carbon atoms and on average from 1 to 12 mol of ethylene oxide (EO) per mole of alcohol, in which the alcohol radical may be linear or, preferably, methyl-branched in position 2 and/or may comprise linear and methyl-branched radicals in a mixture, as are customarily present in oxo alcohol radicals. Particular preference is given, however, to alcohol ethoxylates containing linear radicals from alcohols of natural origin having 12 to 18 carbon atoms, e.g., from coconut, palm, tallow fatty or oleyl alcohol and on average from 2 to 8 EO per mole of alcohol. Preferred ethoxylated alcohols include, for example, C₁₂₋₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO, and mixtures thereof, such as mixtures of C₁₂₋₁₄ alcohol containing 3 EO and C₁₂₋₁₈ alcohol containing 5 EO. The stated degrees of ethoxylation represent statistical mean values, which for a specific product may be an integer or a fraction. Preferred alcohol ethoxylates have a narrowed homolog distribution (narrow range ethoxylates, NREs). In addition to these nonionic surfactants it is also possible to use fatty alcohols containing more than 12 EO. Examples thereof are tallow fatty alcohol containing 14 EO, 25 EO, 30 EO or 40 EO.

As further nonionic surfactants, furthermore, use may also be made of alkyl glycosides of the general formula RO(G)ₓ, where R is a primary straight-chain or methyl-branched aliphatic radical, especially an aliphatic radical methyl-branched in position 2, containing 8 to 22, preferably 12 to 18, carbon atoms, and G is the symbol representing a glycose unit having 5 or 6 carbon atoms, preferably glucose. The degree of oligomerization, x, which indicates the distribution of monoglycosides and oligoglycosides, is any desired number between 1 and 10; preferably, x is from 1.2 to 1.4.

A further class of nonionic surfactants used with preference, which are used either as sole nonionic surfactant or in combination with other nonionic surfactants, are alkoxylated, preferably ethoxylated, or ethoxylated and propoxylated, fatty acid alkyl esters, preferably having 1 to 4 carbon atoms in the alkyl chain.

Nonionic surfactants of the amine oxide type, examples being N-cocoalkyl-N,N-dimethylamine oxide and N-tallowalkyl-N,N-dihydroxyethylamine oxide, and of the fatty acid alkanolamide type, may also be suitable. The amount of these nonionic surfactants is preferably not more than that of the ethoxylated fatty alcohols, in particular not more than half thereof.

Further suitable surfactants are polyhydroxy fatty acid amides of the formula (IX),

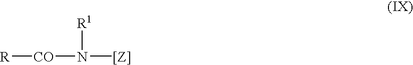

where RCO is an aliphatic acyl radical having 6 to 22 carbon atoms, R¹ is hydrogen or an alkyl or hydroxyalkyl radical having 1 to 4 carbon atoms, and [Z] is a linear or branched polyhydroxyalkyl radical having 3 to 10 carbon atoms and from 3 to 10 hydroxyl groups. The polyhydroxy fatty acid amides are known substances which are customarily obtainable by reductive amination of a reducing sugar with ammonia, an alkylamine or an alkanolamine, and subsequent acylation with a fatty acid, a fatty acid alkyl ester or a fatty acid chloride.

The group of the polyhydroxy fatty acid amides also includes compounds of the formula (X)

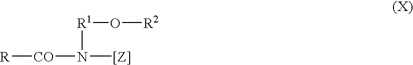

where R is a linear or branched alkyl or alkenyl radical having 7 to 12 carbon atoms, R¹ is a linear, branched or cyclic alkyl radical or an aryl radical having 2 to 8 carbon atoms and R² is a linear, branched or cyclic alkyl radical or an aryl radical or an oxyalkyl radical having 1 to 8 carbon atoms, preference being given to C₁₋₄ alkyl radicals or phenyl radicals, and [Z] is a linear polyhydroxyalkyl radical whose alkyl chain is substituted by at least two hydroxyl groups, or alkoxylated, preferably ethoxylated or propoxylated, derivatives of said radical.

[Z] is preferably obtained by reductive amination of a reduced sugar, e.g., glucose, fructose, maltose, lactose, galactose, mannose, or xylose. The N-alkoxy- or N-aryloxy-substituted compounds may then be converted to the desired polyhydroxy fatty acid amides by reaction with fatty acid methyl esters in the presence of an alkoxide as catalyst.

Preferred surfactants used are low-foaming nonionic surfactants. With particular preference, the detergents of the invention for machine dishwashing comprise nonionic surfactants, especially nonionic surfactants from the group of the alkoxylated alcohols. Particular preference is given to alcohol ethoxylates containing linear radicals from alcohols of natural origin having 12 to 18 carbon atoms, e.g., from coconut, palm, tallow fatty or oleyl alcohol and on average from 2 to 8 EO per mole of alcohol. Preferred ethoxylated alcohols include, for example, C₁₂₋₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO, and mixtures thereof, such as mixtures of C₁₂₋₁₄ alcohol containing 3 EO and C₁₂₋₁₈ alcohol containing 5 EO. The stated degrees of ethoxylation represent statistical mean values, which for a specific product may be an integer or a fraction. Preferred alcohol ethoxylates have a narrowed homolog distribution (narrow range ethoxylates, NREs). In addition to these nonionic surfactants, it is also possible to use fatty alcohols containing more than 12 EO. Examples thereof are tallow fatty alcohol containing 14 EO, 25 EO, 30 EO, or 40 EO.

Particularly preferred detergents of the invention are those which comprise a nonionic surfactant having a melting point above room temperature. Accordingly, preferred detergents are characterized in that in the second part they comprise nonionic surfactant(s), having a melting point above 20° C., preferably above 25° C., with particular preference between 25 and 60° C., and in particular between 26.6 and 43.3° C.

Suitable nonionic surfactants having melting or softening points within the stated temperature range are, for example, low-foaming nonionic surfactants which may be solid or highly viscous at room temperature. If nonionic surfactants which are highly viscous at room temperature are used, then their preferred viscosity is above 20 Pas, preferably above 35 Pas, and in particular above 40 Pas. Also preferred are nonionic surfactants which possess a waxlike consistency at room temperature.

Preferred nonionic surfactants for use that are solid at room temperature originate from the groups of the alkoxylated nonionic surfactants, especially the ethoxylated primary alcohols, and mixtures of these surfactants with surfactants of structurally more complex construction such as polyoxypropylene/polyoxyethylene/polyoxypropylene (PO/EO/PO) surfactants. Such (PO/EO/PO) nonionic surfactants are notable, furthermore, for good foam control.

In one preferred embodiment of the present invention, the nonionic surfactant having a melting point above room temperature is an ethoxylated nonionic surfactant originating from the reaction of a monohydroxy alkanol or alkylphenol having 6 to 20 carbon atoms with preferably at least 12 mol, with particular preference at least 15 mol, in particular at least 20 mol, of ethylene oxide per mole of alcohol or alkylphenol, respectively.

A particularly preferred nonionic surfactant for use that is solid at room temperature is obtained from a straight-chain fatty alcohol having 16 to 20 carbon atoms (C₁₆₋₂₀ alcohol), preferably a C₁₋₈ alcohol, and at least 12 mol, preferably at least 15 mol, and in particular at least 20 mol, of ethylene oxide. Of these, the so-called “narrow range ethoxylates” (see above) are particularly preferred.

Accordingly, particularly preferred detergents of the invention comprise ethoxylated nonionic surfactant(s) obtained from C₆₋₂₀ monohydroxy alkanols or C₆₋₂₀ alkylphenols or C₁₆₋₂₀ fatty alcohols and more than 12 mol, preferably more than 15 mol, and in particular more than 20 mol, of ethylene oxide per mole of alcohol.

The nonionic surfactant which is solid at room temperature preferably further possesses propylene oxide units in the molecule. Preferably, such PO units account for up to 25% by weight, with particular preference up to 20% by weight, and in particular up to 15% by weight, of the overall molar mass of the nonionic surfactant. Particularly preferred nonionic surfactants are ethoxylated monohydroxy alkanols or alkylphenols which additionally comprise polyoxy-ethylene-polyoxypropylene block copolymer units. The alcohol or alkylphenol moiety of such nonionic surfactant molecules in this case makes up preferably more than 30% by weight, with particular preference more than 50% by weight, and in particular more than 70% by weight, of the overall molar mass of such nonionic surfactants. Preferred rinse aids are characterized in that they comprise ethoxylated and propoxylated nonionic surfactants wherein the propylene oxide units in the molecule account for up to 25% by weight, preferably up to 20% by weight, and in particular up to 15% by weight of the overall molar mass of the nonionic surfactant.

Further nonionic surfactants whose use is particularly preferred having melting points above room temperature a contain from 40 to 70% of a polyoxypropylene/polyoxy-ethylene/polyoxypropylene block polymer blend which [lacuna] 75% by weight of an inverted block copolymer of polyoxyethylene and polyoxypropylene containing 17 mol of ethylene oxide and 44 mol of propylene oxide and 25% by weight of a block copolymer of polyoxyethylene and polyoxypropylene, initiated with trimethylolpropane and containing 24 mol of ethylene oxide and 99 mol of propylene oxide per mole of trimethylolpropane.

Nonionic surfactants which may be used with particular preference are, for example, obtainable under the name Poly Tergent® SLF-18 from the company Olin Chemicals.

A further preferred detergent of the invention comprises nonionic surfactants of the formula

R¹O[CH₂CH(CH₃)O]ₓ[CH₂CH₂O]_{y}[CH₂CH(OH)R²]

in which R¹ is a linear or branched aliphatic hydrocarbon radical having 4 to 18 carbon atoms, or mixtures thereof, R² is a linear or branched hydrocarbon radical having 2 to 26 carbon atoms, or mixtures thereof, and x is between 0.5 and 1.5, and y is at least 15.

Further nonionic surfactants which may be used with preference are the endgroup-capped poly(oxyalkylated) nonionic surfactants of the formula

R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is between 1 and 30, k and j are between 1 and 12, preferably between 1 and 5. Where x≧2, each R³ in the above formula may be different. R¹ and R² are preferably linear or branched, saturated or unsaturated, aliphatic or aromatic hydrocarbon radicals having 6 to 22 carbon atoms, radicals having 8 to 18 carbon atoms being particularly preferred. For the radical R³, H, —CH₃ or —CH₂CH₃ are particularly preferred. Particularly preferred values for x lie within the range from 1 to 20, in particular from 6 to 15.

As described above, each R³ in the above formula may be different if x≧2. By this means it is possible to vary the alkylene oxide unit in the square brackets. If x, for example, is 3, the radical R³ may be selected in order to form ethylene oxide (R³═H), or propylene oxide (R³═CH₃) units, which may be added on to one another in any sequence, examples being (EO)(PO)(EO), (EO)(EO)(PO), (EO)(EO)(EO), (PO)(EO)(PO), (PO)(PO)(EO) and (PO)(PO)(PO). The value of 3 for x has been chosen by way of example in this case and it is entirely possible for it to be larger, the scope for variation increasing as the values of x go up and embracing, for example, a large number of (EO) groups, combined with a small number of (PO) groups, or vice versa.

Particularly preferred endgroup-capped poly(oxy-alkylated) alcohols of the above formula have values of k=1 and j=1, thereby simplifying the above formula to

R¹O[CH₂CH(R³)O]ₓCH₂CH(OH)CH₂OR².

In the last-mentioned formula, R¹, R² and R³ are as defined above and x stands for numbers from 1 to 30, preferably from 1 to 20, and in particular from 6 to 18. Particular preference is given to surfactants wherein the radicals R¹ and R² have 9 to 14 carbon atoms, R³ is H, and x adopts values from 6 to 15.

Summarizing the last-mentioned statements, preference is given to detergents of the invention which comprise endgroup-capped poly(oxyalkylated) nonionic surfactants of the formula

R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having 1 to 30 carbon atoms, R³ is H or a methyl, ethyl, n-propyl, isopropyl, n-butyl, 2-butyl or 2-methyl-2-butyl radical, x is between 1 and 30, k and j are between 1 and 12, preferably between 1 and 5, particular preference being given to surfactants of the type

R¹O[CH₂CH(R³)O]ₓCH₂CH(OH)CH₂OR²

in which x stands for numbers from 1 to 30, preferably from 1 to 20, and in particular from 6 to 18.

Naturally, the aforementioned surfactants may additionally be present in the first part of the detergents of the invention. It is also possible, furthermore, for the second part to be given a surfactant-free formulation and for all of the aforementioned surfactants to be present in the first part (see below).

In addition to one or more substances from the groups of the builders, acidifiers, chelating agents or scale inhibiting polymers and the surfactants present optionally, the second part may comprise further customary ingredients of detergents. In particular, the presence of bleaches and/or bleach activators and/or bleaching catalysts and/or enzymes and/or corrosion inhibitors (silver protectants) and/or dyes and/or fragrances in the second part may bring further performance advantages.

In accordance with the invention the second part has a suitable coating whose effect is to cause the ingredients of the second part to be released, and to develop their effect, substantially not until the rinse cycle of the dishwasher. A coating of this kind, depending on the material chosen, customarily has thicknesses of from 10 to 1000 μm, preference being given in the context of the present invention to coat thicknesses between 20 and 800 μm, in particular between 50 and 400 μm.

The coating may be of uniform composition, e.g., may consist of a single material, but it is also possible to employ multilayer coatings, preference being given in the context of the present invention to two-, three- or four-layer coatings.

The coating protects the second part against premature dissolution in the main wash cycle and any intermediate wash cycles. In the rinse cycle the coating must be rapidly dissolved or otherwise destroyed in order to release the ingredients of the second part. A number of release mechanisms are appropriate in this context, and utilize altered properties of the coating materials as a function of varying external conditions. In this way, conditions which prevail within the dishwasher and which differ in the main wash cycle and rinse cycle are utilized to transfer the second part into the rinse cycle. As a result of the change in external conditions the coating “switches” and releases the second part. Appropriate “switches” include temperature-controlled and/or enzyme-controlled and/or redox-controlled and/or electrolyte-controlled and/or pH-controlled systems.

Temperature-controlled systems, for example, may consist in coating the second part with a substance which melts only above a certain temperature and is then washed away or only becomes soluble in the application medium above a certain temperature. Examples of such coating substances, which are described in detail later on below, include paraffins. Another mechanism of temperature control can be realized using substances which dissolve better at low temperatures than at high temperatures. Such substances, having what is termed a “low critical solution temperature”, are referred to as LCST substances or else as substances having a lower critical separation temperature. In order to prevent the substances dissolving the first time water enters the machine (before the main wash cycle), they must be provided with a further coating which dissolves or is otherwise destroyed during the main wash cycle. At the hot temperatures of the wash cycle, the LCST substance protects the second part, while at the low temperatures of the rinse cycle it dissolves and releases the ingredients.

Detergents preferred in the context of the present invention are therefore characterized in that the coating of the second part comprises an LCST polymer.

The detergent can be employed with particular advantage in machine methods where the active substance is to be released in a wash cycle after the cleaning step. Examples are the machine cleaning of kitchen- and tableware both in the household and in the commercial sector. As a result of formulation in accordance with the invention, the active substances remain at least partly unchanged following a heat treatment in a liquid medium, e.g., after the main wash cycle, and the active substance is not released until after cooling following the heat treatment, i.e., in the rinse cycle.

In accordance with the preferred embodiment of the present invention the second part is coated with an LCST substance. These substances are generally polymers. Depending on application conditions, the lower critical separation temperature should lie between room temperature and the temperature of the heat treatment, for example, between 20° C., preferably 30° C., and 100° C., in particular between 30° C. and 50° C. Preference is given here to detergents wherein the lower critical separation temperature of the LCST polymer lies between 20° C. and 90° C.

One LCST polymer suitable in the context of the present invention is, for example, polyvinylcaprolactam (PVCap).

Further-preferred detergents are characterized in that the LCST polymer is selected from cellulose derivatives, mono- or di-N-alkylated acrylamides, copolymers of mono- or di-N-substituted acrylamides with acrylamides and/or acrylates or acrylic acids. The LCST substances are selected with particular preference from alkylated and/or hydroxyalkylated polysaccharides, cellulose ethers, polyisopropylacrylamide, copolymers of polyisopropylacrylamide, and blends of these substances. Corresponding detergents which are characterized in that the LCST polymer is selected from cellulose ethers, polyisopropylacrylamide, copolymers of polyisopropylacrylamide, and blends of these substances are preferred in accordance with the invention.

Examples of alkylated and/or hydroxyalkylated poly-saccharides are methylhydroxypropylmethylcellulose (MHPC), ethyl(hydroxyethyl)cellulose (EHEC), hydroxypropylcellulose (HPC), methylcellulose (MC), ethylcellulose (EC), carboxymethylcellulose (CMC), carboxymethylmethylcellulose (CMMC), hydroxybutylcellulose (HBC), hydroxybutylmethylcellulose (HBMC), hydroxyethylcellulose (HEC), hydroxyethylcarboxymethylcellulose (HECMC), hydroxyethylethylcellulose (HEEC), hydroxypropylcellulose (HPC), hydroxypropyl-carboxymethylcellulose (HPCMC), hydroxyethylmethylcellulose (HEMC), methylhydroxyethylcellulose (MHEC), methylhydroxyethylpropylcellulose (MHEPC), methylcellulose (MC) and propylcellulose (PC) and mixtures thereof, preference being given to carboxymethylcellulose, methylcellulose, methylhydroxyethylcellulose and methylhydroxypropylcellulose, and also to the alkali metal salts of CMCs and to the slightly ethoxylated MCs, or mixtures of the above.

Further examples of LCST substances are cellulose ethers and also mixtures of cellulose ethers with carboxymethylcellulose (CMC). Further polymers which exhibit a lower critical separation temperature in water and which are likewise suitable are polymers of mono- or di-N-alkylated acrylamides, copolymers of mono- or di-N-substituted acrylamides with acrylates and/or acrylic acids, or mixtures of interpenetrating networks of the abovementioned (co)polymers. Also suitable, furthermore, are polyethylene oxide or copolymers thereof, such as ethylene oxide/propylene oxide copolymers and graft copolymers of alkylated acrylamides with polyethylene oxide, polymethacrylic acid, polyvinyl alcohol and copolymers thereof, polyvinyl methyl ethers, certain proteins such as poly(VATGVV), a repeating unit in the natural protein elastin, and certain alginates. Mixtures of these polymers with salts or surfactants may likewise be used as LCST substance. By means of such additives or by way of the degree of crosslinking of the polymers it is possible to modify the LCST (lower critical separation temperature) accordingly.

In one preferred embodiment of the present invention the second part is coated with a further material which is soluble at a temperature above the lower separation temperature of the LCST substance or has a melting point above this temperature or a retarded solubility, i.e., can be released above the lower separation temperature of the LCST coat. This coat serves to protect the mixture of active substance and LCST substance against water or other media which can dissolve them prior to the heat treatment. This further coat ought not to be liquid at room temperature, and preferably has a melting or softening point at a temperature which lies equal with or above the lower critical separation temperature of the LCST polymer. With particular preference the melting point of said coat lies between the lower critical separation temperature and the temperature of the heat treatment. In one particular version of this embodiment the LCST polymers and the further substance are mixed with one another and applied to the material to be encapsulated.

The further substance preferably has a melting range which lies between about 35° C. and about 75° C. In the present case that means that the melting range occurs within the stated temperature interval, and does not denote the breadth of the melting range.

The abovementioned properties are in general possessed by what are called waxes. The term “waxes” is applied to a range of natural or synthetic substances which melt without decomposition, generally at above 35° C., and are of comparatively low viscosity, without stringing, even at just a little above the melting point. They have a highly temperature-dependent consistency and solubility. According to their origin, the waxes are divided into three groups: the natural waxes, chemically modified waxes, and the synthetic waxes.

The natural waxes include, for example, plant waxes such as candelilla wax, carnauba wax, Japan wax, esparto grass wax, cork wax, guaruma wax, rice germ oil wax, sugar cane wax, ouricury wax, or montan wax, animal waxes such as beeswax, shellac wax, spermaceti, lanolin (wool wax), or uropygial grease, mineral waxes such as ceresin or ozokerite (earth wax), or petrochemical waxes such as petrolatum, paraffin waxes or microcrystalline waxes.

The chemically modified waxes include, for example, hard waxes such as montan ester waxes, sassol waxes, or hydrogenated jojoba waxes.

By synthetic waxes are meant, in general, polyalkylene waxes or polyalkylene glycol waxes. As coating materials it is also possible to use compounds from other classes of substance which meet the stated requirements in terms of softening point. Examples of synthetic compounds which have proven suitable are higher esters of phthalic acid, especially dicyclohexyl phthalate, which is available commercially under the name Unimoll® 66 (Bayer AG). Also suitable are synthetically prepared waxes from lower carboxylic acids and fatty alcohols, an example being dimyristyl tartrate, which is available under the name Cosmacol® ETLP (Condea). Conversely, synthetic or partially synthetic esters of lower alcohols with fatty acids from natural sources may also be used. This class of substance includes, for example, Tegin® 90 (Goldschmidt), a glyceryl monostearate palmitate. Shellac as well, for example, Schellack-KPS-Dreiring-SP (Kalkhoff GmbH), may be used as a further substance.

Likewise counted among the waxes in the context of the present invention are, for example, the so-called wax alcohols. Wax alcohols are relatively high molecular mass, water-insoluble fatty alcohols having in general from about 22 to 40 carbon atoms. The wax alcohols occur, for example, in the form of wax esters of relatively high molecular mass fatty acids (wax acids) as a principal constituent of many natural waxes. Examples of wax alcohols are lignoceryl alcohol (1-tetracosanol), cetyl alcohol, myristyl alcohol, and melissyl alcohol. The coating may, if desired, also include wool wax alcohols, by which are meant triterpenoid and steroid alcohols, an example being lanolin, which is available under the commercial designation Argowax® (Pamentier & Co.), for example. Likewise possible for use, at least proportionally, as a constituent of the coating are, in the context of the present invention, fatty acid glycerol esters or fatty acid alkanolamides, and also, if desired, water-insoluble or only sparingly water-soluble polyalkylene glycol compounds.

Further suitable substances having a melting point above the LCST of the underlying coating material are saturated aliphatic hydrocarbons (paraffins).

Suitable coating materials also include all water-soluble, water-dispersible, and water-insoluble polymers which have a melting point which lies above the lower critical separation temperature of the LCST polymer used in accordance with the invention or which are soluble above this temperature. Suitable polymers are room-temperature-solid polyethylene glycols, polyvinyl alcohols, polyacrylic acid and derivatives thereof. Gelatin has also proven suitable, moreover. Particular preference is given to using polyvinyl acetate (PVAc) as material for protecting the LCST coat (“topcoating”).

Occasionally it may be sufficient for protection of the LCST polymer coat for it to be shielded from initially cold water by a water-soluble coating. This water-soluble coating is merely required to have a sufficiently delayed solubility that the coat is stable for a sufficiently long period. For this purpose it is possible, for example, to use polyalkylene glycols preferably with a relatively high molecular weight.

The second part can be coated with the LCST substance and/or the further material in a manner known per se. The substances may be sprayed on in the form, for example, of a melt or solution or dispersion, or the mixture can be dipped into the melt, solution or dispersion or mixed therewith in an appropriate mixer. Coating in a fluidized-bed apparatus is also possible. In the case of the spraying method, all of the methods of producing coated tablets, capsules, and particles that are established in pharmacy and food technology are appropriate. The polymer suspension or solution is either sprayed on discontinuously in small portions, with the particles, for example, being transported on a conveyor belt through a mist of liquid and then dried in a stream of air, or sprayed continuously with simultaneous drying by means of the inblown stream of air in fluidized bed or flotation coating apparatus. Also conceivable is the film coating process, if LCST polymers are added in sufficiently high concentration to the coatings syrups. The second coat is applied analogously.

In another preferred embodiment of the invention, the ingredients of the second part are released by means of an enzyme-controlled coating. In this case, enzymatically degradable (enzyme-sensitive) materials are used as coating material. The enzymes typically present in detergents bring about a breakdown in the enzyme-sensitive coating material after a certain exposure time and, in doing so, cause release of the detergent active substance or substances enclosed in the second part.

Suitable enzyme-sensitive materials include preferably cellulose derivatives, starch or starch derivatives, partially oxidized starch derivatives, glycerides, certain proteins, and mixtures of these. Enzymes used in detergents are preferably proteases, amylases and/or lipases.

Compositions of the invention can be produced by coating conventional solid detergents or components thereof, present in the form of granules and/or agglomerates, pellets, extrudates, tablets or capsules, with the enzyme-sensitive material. Where such enzymic compositions or components for detergents are introduced together with conventional detergents into cleaning liquors, the active substances enclosed are not released until after the at least partial breakdown of the enzyme-sensitive coating materials.

A further preferred embodiment of the invention consists in using a redox system as a (physico)chemical switch effecting controlled release of active substance. As in the case of enzyme-controlled active substance release, with redox-controlled active substance release as well the redox materials can be used as coating material in particular for shaped bodies, tablets for example, or capsules of detergent active substances. After a certain exposure time of redox-active components typically present in detergents, there is a chemical change in the redox-sensitive coating material and, going hand in hand therewith, release of the detergent active substance or substances enclosed in the coated shaped bodies, granules or capsules.

Suitable redox-sensitive materials include, in particular, oxidation-sensitive organic and inorganic substances, including polymers. It is particularly preferred to use polyvinylpyridine as redox-sensitive material. Redox-active ingredients of detergents include, in particular, oxidizing agents such as percarbonate and the like, especially in combination with bleach activators, especially tetraacetylethylene-diamine (TAED) and further typical bleach activators.

Solid compositions of the invention can be produced by coating conventional solid detergents or components thereof, present in the form of granules and/or agglomerates, pellets, extrudates, tablets or capsules, with the redox-sensitive material. Where compositions comprising redox-sensitive materials or detergent components comprising redox-sensitive materials are introduced together with conventional detergents into cleaning liquors, the active substances enclosed are not released until after the at least partial oxidative breakdown of the redox-sensitive coating materials.

In the context of the present invention it is also possible to use a (physico)chemical switch which produces electrolyte-controlled release of active substance. Here it is possible to exploit the difference in electrolyte content between the cleaning cycle and the rinse cycle in the case of machine dishwashing. A further preferred embodiment of the invention therefore provides a detergent wherein the second part is coated with an electrolyte-sensitive substance, the active substance(s) of the second part being released as a consequence of a change which occurs in the electrolyte concentration.

A coating of this kind with a material which dissolves better at a low ionic strength than at a high ionic strength, hereinafter referred to as “electrolyte-sensitive material”, releases the second part as a function of the salinity during the application. Suitable electrolyte-sensitive materials include the following classes of substance:

a) cellulose derivatives, e.g., methylcellulose, hydroxyethylcellulose, hydroxypropylcellulose, methylhydroxyethylcellulose, carboxymethyl-cellulose with different degrees of substitution

b) polyvinyl alcohols with different degrees of saponification and molecular weights

c) polyelectrolytes, e.g., polyacrylates, and with particular preference polystyrenesulfonate

These materials possess good solubility in pure water or with a low ionic load but become insoluble or very sparingly soluble in the presence of higher salt concentrations. The particular salt concentration required to render the substances insoluble is different. With these “switches” as well it may be necessary to apply a second coating which prevents the first coating layer from dissolving due to pure water at the beginning of the cleaning program.

Looking at the process of the machine cleaning of kitchen- and tableware, the pH of the wash liquor during cleaning is approximately 10. Accordingly, the substantial products available commercially for machine dishwashing contain alkali. In particular, in the case of the predominant majority of machine dishwashers and their different cleaning programs, the wash liquor is pumped off after the cleaning cycle and replaced by fresh water. This is accompanied, independently of the temperature of the water, by a drop in pH by about 1 to 2 pH units. The precise magnitude of the drop in pH is dependent on the residual amount of lye remaining in the machine, which is approximately 2%.

In a further preferred embodiment of the present invention, therefore, it is possible to utilize a change in pH to effect targeted release of active substances.

In this embodiment of the invention the (physico)chemical switches used as coating material for the second part are those which undergo a change in physicochemical properties when there is a change in the pH of the application liquor. It is particularly preferred here to use, as (physico)chemical switches, substances which exhibit an enhanced solubility in water as a consequence of a change in pH that occurs in the application liquor. Alternatively or additionally, preference is given to those switch substances which exhibit a change, in particular a decrease, in the diffusion density on the corresponding change in the pH of the application liquor. Advantageous compositions, especially machine dishwashing detergents, are those which comprise, as (physico)chemical switch, a substance which, when there occurs in the application liquor a change in the pH in the range from 11 to 6, preferably from 10 to 7, undergoes a change in its physicochemical properties and in so doing, preferably at a decreasing pH in the range from 10 to 7, in particular from 10 to 8, exhibits an enhanced solubility in water and/or a decrease in diffusion density.

Suitable substances which can be used as (physico)chemical switches of this kind are basic in nature and are, in particular, basic polymers and/or copolymers.

The principle of pH-dependent solubility in water is generally based on protonation or deprotonation of functional side groups of the polymer molecules, as a result of which their charge state changes accordingly. The polymer, then, must be in a state such that it dissolves in water in the charged state, which is stable at a certain pH, but precipitates out in the uncharged state at a different pH. In the context of the present invention it is preferred for the polymers used in accordance with the invention to have a lower water-solubility at a higher pH than at lower pH values, or even to become insoluble in water at relatively high pH.

Polymers with pH-dependent solubility are known in particular from pharmacy. Here, use is made, for example, of acid-insoluble polymers in order to give tablets a coating which is resistant to gastric juices but is soluble in the intestinal fluid. Acid-insoluble polymers of this kind are generally based on derivatives of polyacrylic acid, which is present in the acidic range in undissociated and thus insoluble form, but in the alkaline range, typically at pH 8, is neutralized and goes into solution as a polyanion.

For the converse case as well—soluble in the acidic range, insoluble in the alkaline range—examples are known within the prior art. These substances, in which the polymer molecules usually carry amino-substituted side chains, are utilized, for example, for the manufacture of tablet coatings which are soluble in gastric juices. They generally dissolve at a pH below 5. Polymers in which the solubility change from soluble to insoluble occurs at relatively high pH are not known from pharmacy, since such pH values are of no physiological relevance.

Particularly preferred suitable substances here are basic (co)polymers which contain amino groups or aminoalkyl groups. Comonomers can be, for example, typical acrylates, methacrylates, maleates or derivatives of these compounds. One particularly suitable aminoalkyl-methacrylate copolymer is sold by Rohm (Eudragit®).

For application, however, not only the thermodynamic solubility but also the dissolution kinetics of a film substance or the decrease in its mechanical stability may also be of importance. The dissolution kinetics of the switch substances used in accordance with the invention are pH-dependent at room temperature into the alkaline range, i.e., the films are stable for considerably longer at a pH of 10 than at a pH of 8.5, despite being thermodynamically soluble at both pH values.

In a further embodiment of the present invention, therefore, polymers are used whose solubility in water fluctuates between pH 6 and 7, and which are less readily soluble at a higher pH than at a lower pH. As already described above, suitable polymers contain basic groups, examples being primary, secondary or tertiary amino groups, imino groups, amido groups or pyridine groups, in general those which possess a quaternizable nitrogen atom. At a relatively low pH they are in protonated form, and so the polymer is soluble. At higher pH, the molecule undergoes transition to the uncharged state and becomes insoluble. As a rule the transition—called “switching point” hereinafter, takes place irrespective of the pK_{b} value of the basic groups and of their density along the polymer chain in the acidic pH range. The present invention therefore further provides a polymer wherein the switching point is situated in a range between pH 6 and 7.

This shift in the switching point occurs in principle as follows:

depending on the pK_{b}, only a very small pH-dependent change in the charge state of the polymer in solution takes place in the higher pH range. Therefore it must be feasible to influence the solubility decisively through this small change in charge state. The polymer must therefore have precisely such a hydrophilicity that it is insoluble in the fully uncharged state but becomes soluble even in the case of slight charging.

To set the hydrophilicity it is possible to use the following methods:

Copolymerization of a monomer having a basic function with a more hydrophilic monomer. The switching point is influenced by the incorporation ratio of the respective comonomers.

Hydrophilicization of the polymer carrying basic groups by means of a polymer-analogous reaction. The degree of modification influences the switching point.

In addition to simple hydrophilicization it is also possible to introduce basic functions having different pK_{b} values. Through the ratio of the two groups and the resulting hydrophilicity of the molecule it is possible to influence the switching point.

One particularly preferred polymer of this class of substance is an N-oxidized polyvinylpyridine.

It is not necessary here for the polymer of the coating of the second part to dissolve completely under the corresponding pH conditions in order to release the active substance. Instead, it is sufficient if, for example, the permeability of a polymer film changes and, for example, the penetration of water into the active substance formulation is made possible. By this means it is possible for a secondary effect, for example, the activation of an effervescent system or the swelling of a water-swellable disintegrant, which are known in particular from pharmacy, to ensure the full release of the active substance.

In another preferred embodiment of the invention, substances known as pH shift boosters are used in addition to the abovementioned switches. By this means it is possible, at least predominantly, to prevent the occurrence after the rinse cycle of residues consisting in particular of the pH-dependently soluble substance itself. Suitable pH shift boosters for the purposes of this invention are all substances and formulations which are able to increase the extent of the pH shift either locally, i.e., in the direct vicinity of the particular pH-shift-sensitive substance used, or else in a generalized fashion, i.e., throughout the wash liquor. They include all organic and/or inorganic water-soluble acids or acidically reacting salts, in particular at least one substance from the group consisting of alkylbenzenesulfonic acids, alkylsulfuric acids, citric acid, oxalic acid and/or alkali metal hydrogen sulfates.

The pH shift booster can be incorporated into the detergent. In a further embodiment of the invention, however, it is also possible to supply the pH shift booster to the machine externally, either after the end of the cleaning cycle or at the beginning of the rinse cycle, or to release it by means of a special delivery system (by coating with a coating agent which is slow to dissolve) or by diffusion from a matrix material.

As already mentioned, the coating of the second part of the detergents of the invention may also consist of two or more layers. In part this is necessary in order to protect certain coating layers, during the main cleaning cycle, by a second layer (see above); in part, however, an undercoating may be necessary in order to provide an effectively adhering and uniform substrate for the functional coating. Also conceivable, of course, is the combination of an undercoating with a functional coating and a further protective coat. In this embodiment, the second part possesses a three-layer coating. Detergents wherein the coating of the second part is composed of a plurality of coating layers, preferably of two or three coating layers, are preferred in accordance with the invention.

A description follows of preferred coating materials for undercoatings or for external coatings which protect, where appropriate, the “functional coating”.

Preferred coating materials for an optional inner or outer coating layer are the polymers known from the prior art. Particular preference is given to detergents wherein the coating layer on the second part is composed of a polymer having a molar mass of between 5000 and 500 000 daltons, preferably between 7500 and 250 000 daltons, and in particular between 10 000 and 100 000 daltons. In view of the media typically incorporated into the detergents, particular preference is given to detergents wherein the external coating layer on the second part is composed of a water-soluble polymer.

Preferred polymers of this kind may be synthetic or natural in origin. Where polymers on a natural or partly natural basis are employed as coating material, the coating material is preferably selected from one or more substances from the group consisting of carrageenan, guar, pectin, xanthan, cellulose and its derivatives, starch and its derivatives, and gelatin.

Carrageenan is a formed extract, with a composition similar to that of agar, of North Atlantic red algae which belong to the Florideae, and is named for the Irish coastal town of Carragheen. The carrageenan, precipitated from the hot-water extract of the algae, is a colorless to sandy-colored powder having molar masses of 100 000-800 000 and a sulfate content of approximately 25%, which is very readily soluble in warm water. In carrageenan, three principal constituents are distinguished: the yellow-forming f fraction consists of D-galactose 4-sulfate and 3,6-anhydro-α-D-galactose, having alternate glycoside linkages in the 1,3 and 1,4 positions (agar, in contrast, contains 3,6-anhydro-α-L-galactose). The non-gelling I fraction is composed of D-galactose 2-sulfate with 1,3-glycoside linkages and of D-galactose 2,6-disulfate residues with 1,4 linkages, and is readily soluble in cold water. i-Carrageenan, composed of D-galactose 4-sulfate in 1,3 linkage and 3,6-anhydro-a-D-galactose 2-sulfate in 1,4 linkage, is both water-soluble and gel-forming. Further types of carrageenan are likewise labeled with Greek letters: α, β, γ, μ, ν, ξ, π, ω, χ. The nature of cations present (K, NH₄, Na, Mg, Ca) also influences the solubility of the carrageenans. Semisynthetic products which contain only one ionic type and are likewise possible for use as coating materials in the context of the present invention are also called carrag(h)eenates.

The guar which may be used as a coating material in the context of the present invention, also called guar flour, is a grayish white powder obtained by milling the endosperm of the guar bean (Cyamopsis tetragonobolus), which belongs to the family of the Leguminosae and was originally endemic in the Indian and Pakistani region but has since been cultivated in other countries as well, for example, in the southern USA. The principal constituent of guar, with up to about 85% by weight of the dry matter, is guaran (guar gum, Cyamopsis gum); secondary constituents are proteins, lipids, and cellulose. Guaran itself is a polygalactomannan, i.e., a polysaccharide whose linear chain is composed of unsubstituted mannose units (see formula XI) and mannose units substituted in the C6 position by a galactose residue (see formula (XII) in β-D-(1→4) linkage.

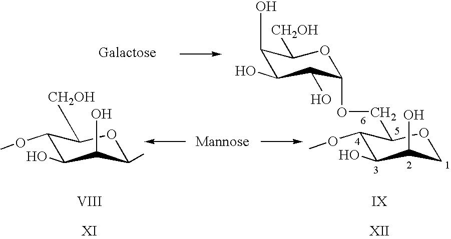

The ratio of XI:XII is approximately 2:1; the XII units, in contrast to what was originally assumed, are not strictly alternating but are instead arranged in pairs or triplets in the polygalactomannan molecule. Data on the molar mass of guaran vary with values of approximately 2.2·10⁵-2.2·10⁶ g/mol, depending on the degree of purity of the polysaccharide—the high value was determined on a highly purified product—significantly and correspond to approximately 1350-13 500 sugar units/macromolecule. Guaran is insoluble in the majority of organic solvents.

The pectins, which are likewise suitable for use as coating material, are high molecular mass glycosidic plant substances which are very widespread in fruits, roots, and leaves. Pectins consist essentially of chains of 1,4-α-glycosidically linked galacturonic acid units with 20-80% of their acid groups esterified with methanol, a distinction being made between high-esterification (>50%) and low-esterification (<50%) pectins. The pectins have a folded leaf structure which positions them in the center between starch and cellulose molecules. Their macromolecules also contain some glucose, galactose, xylose and arabinose, and have weakly acidic properties.

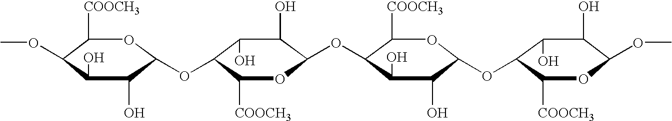

Fruit pectin contains 95%, beet pectin up to 85% galacturonic acid. The molar masses of the various pectins vary between 10 000 and 500 000. The structural properties as well are highly dependent on the degree of polymerization; for example, the fruit pectins in the dried state form asbestoslike fibers while the flax pectins form fine, granular powders.

The pectins are prepared by extraction with dilute acids predominantly from the inner portions of citrus fruit peels, fruit residues, or sugar beet chips.

Xanthan may also be used as an outer coating material for the second part in accordance with the invention. Xanthan is a microbial anionic heteropolysaccharide produced by Xanthomonas campestris and certain other species under aerobic conditions, having a molar mass of from 2 to 15 million daltons. Xanthan is formed of a chain comprising β-1,4-linked glucose (cellulose) with side chains. The structure of the subgroups comprises glucose, mannose, glucuronic acid, acetate, and pyruvate, the viscosity of the xanthan being determined by the number of pyruvate units. Xanthan may be described by the following formula:

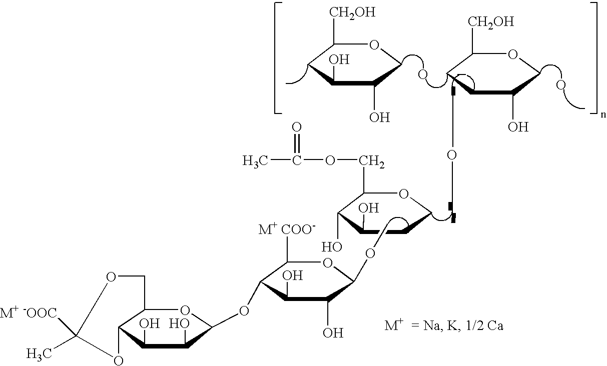

### Basic Unit of Xanthan

The celluloses and their derivatives are likewise suitable as coating materials. Pure cellulose has the formal empirical composition (C₆H₁₀O₅) n and, viewed formally, constitutes a β-1,4-polyacetal of cellobiose, which in turn is composed of two molecules of glucose. Suitable celluloses consist of about 500 to 5000 glucose units and, accordingly, have average molar masses of from 50 000 to 500 000. As cellulose-based coating material it is also possible, in the context of the present invention, to use cellulose derivatives obtainable from cellulose by polymer-analogous reactions. Such chemically modified celluloses include, for example, products of esterifications or etherifications in which hydroxy hydrogen atoms have been substituted. However, celluloses in which the hydroxyl groups have been replaced by functional groups not attached via an oxygen atom can also be employed as cellulose derivatives. The group of the cellulose derivatives includes, for example, alkali metal celluloses, carboxymethylcellulose (CMC), cellulose esters and ethers, and aminocelluloses.

In addition to cellulose and cellulose derivatives, it is also possible to use (modified) dextrins, starch, and starch derivatives as coating materials.

Suitable nonionic organic coating materials are dextrins, examples being oligomers and polymers of carbohydrates obtainable by partial hydrolysis from starches. The hydrolysis may be conducted in accordance with customary processes—for example, acid—or enzyme-catalyzed processes. The products in question are preferably hydrolysis products having average molar masses in the range from 400 to 500 000 g/mol. Preference is given to a polysaccharide having a dextrose equivalent (DE) in the range from 0.5 to 40, in particular from 2 to 30, DE being a customary measure of the reducing action of a polysaccharide in comparison with dextrose, which possesses a DE of 100. Dextrins suitable for use include not only maltodextrins having a DE of between 3 and 20 and dry glucose syrups having a DE of between 20 and 37 but also what are known as yellow dextrins and white dextrins having higher molar masses in the range from 2000 to 30 000 g/mol.

The oxidized derivatives of such dextrins comprise their reaction products with oxidizing agents capable of oxidizing at least one alcohol function of the saccharide ring to the carboxylic acid function. A product oxidized at C₆ of the saccharide ring may be particularly advantageous.

Starch as well may be used as coating material for the second part. Starch is a homoglycan in which the glucose units are linked α-glycosidically. Starch is composed of two components of different molecular weight: approximately 20-30% straight-chain amylose (MW approx. 50 000-150 000) and 70-80% branched-chain amylopectin (MW approx. 300 000-2 000 000), with small amounts of lipids, phosphoric acid, and cations being present as well. Whereas amylose forms long, helical, interlooped chains comprising approximately 300-1200 glucose molecules, owing to the 1,4 linkage, in the case of amylopectin the chain branches by 1,6 linkage, after on average 25 glucose units, to form a treelike structure comprising approximately 1500-12 000 molecules of glucose. In addition to straight starch, starch derivatives obtainable by polymer-analogous reactions from starch are also suitable coating materials in the context of the present invention. Examples of such chemically modified starches include products of esterifications and etherifications in which hydroxy hydrogen atoms have been substituted. Alternatively, starches in which the hydroxy groups have been replaced by functional groups not attached via an oxygen atom may be used as starch derivatives. The group of the starch derivatives includes, for example, alkali metal starches, carboxymethylstarch (CMS), starch esters and ethers, and amino starches.

Among the proteins and modified proteins, gelatin is of outstanding significance as coating material. Gelatin is a polypeptide (molar mass: approx. 15 000->250 000 g/mol) obtained principally by hydrolysis under acidic or alkaline conditions of the collagen present in the skin and bones of animals. The amino acid composition of gelatin corresponds largely to that of the collagen from which it was obtained, and varies as a function of its provenance. The use of gelatin as a water-soluble envelope material is extremely widespread, especially in pharmacy, in the form of hard or soft gelatin capsules.

Further polymers suitable for use as outer coating materials for the second part are synthetic polymers, which are preferably water-swellable and/or water-soluble. Such synthetic-based polymers can be “tailored” for the desired coating permeability on storage and dissolution of the coating layer on application. Particularly preferred detergents of the invention are characterized in that the outer coating material for the second part is selected from a polymer or polymer mixture, the polymer or at least 50% by weight of the polymer mixture being selected from

a) water-soluble nonionic polymers from the group of

a2) polyvinylpyrrolidones

a2) vinylpyrrolidone-vinyl ester copolymers

a3) cellulose ethers

b) water-soluble amphoteric polymers from the group of

b2) alkylacrylamide-acrylic acid copolymers

b2) alkylacrylamide-methacrylic acid copolymers

b3) alkylacrylamide-methylmethacrylic acid copolymers

b4) alkylacrylamide-acrylic acid-alkylaminoalkyl-(meth)acrylic acid copolymers

b5) alkylacrylamide-methacrylic acid-alkylamino-alkyl(meth)acrylic acid copolymers

b6) alkylacrylamide-methylmethacrylic acid-alkyl-aminoalkyl(meth)acrylic acid copolymers

b7) alkylacrylamide-alkyl methacrylate-alkylamino-ethyl methacrylate-alkyl methacrylate copolymers

b8) copolymers of

b8i) unsaturated carboxylic acids

b8ii) cationically derivatized unsaturated carboxylic acids

b8iii) if desired, further ionic or nonionogenic monomers

c) water-soluble zwitterionic polymers from the group of

c1) acrylamidoalkyltrialkylammonium chloride-acrylic acid copolymers and their alkali metal and ammonium salts

c2) acrylamidoalkyltrialkylammonium chloride-methacrylic acid copolymers and their alkali metal and ammonium salts

c3) methacroylethyl betaine-methacrylate copolymers

d) water-soluble anionic polymers from the group of

d1) vinyl acetate-crotonic acid copolymers

d2) vinylpyrrolidone-vinyl acrylate copolymers

d3) acrylic acid-ethyl acrylate-N-tert-butylacryl-amide terpolymers

d4) graft polymers of vinyl esters, esters of acrylic acid or methacrylic acid alone or in a mixture, copolymerized with crotonic acid, acrylic acid or methacrylic acid with poly-alkylene oxides and/or polyalkylene glycols

d5) grafted and crosslinked copolymers from the copolymerization of

d5i) at least one monomer of the nonionic type,

d5ii) at least one monomer of the ionic type,

d5iii) polyethylene glycol, and

d5iv) a crosslinker

d6) copolymers obtained by copolymerizing at least one monomer from each of the three following groups:

d6i) esters of unsaturated alcohols and short-chain saturated carboxylic acids and/or esters of short-chain saturated alcohols and unsaturated carboxylic acids,

d6ii) unsaturated carboxylic acids,

d6iii) esters of long-chain carboxylic acids and unsaturated alcohols and/or esters of the carboxylic acids of group d6ii) with saturated or unsaturated, straight-chain or branched C₈₋₁₈ alcohol

d7) terpolymers of crotonic acid, vinyl acetate and an allyl or methallyl ester

d8) tetra- and pentapolymers of

d8i) crotonic acid or allyloxyacetic acid

d8ii) vinyl acetate or vinyl propionate

d8iii) branched allyl or methallyl esters

d8iv) vinyl ethers, vinyl esters or straight-chain allyl or methallyl esters

d9) crotonic acid copolymers with one or more monomers from the group consisting of ethylene, vinylbenzene, vinyl methyl ether, acrylamide and water-soluble salts thereof

d10) terpolymers of vinyl acetate, crotonic acid and vinyl esters of a saturated aliphatic α-branched monocarboxylic acid

e) water-soluble cationic polymers from the group of

e1) quaternized cellulose derivatives

e2) polysiloxanes with quaternary groups

e3) cationic guar derivatives

e4) polymeric dimethyldiallylammonium salts and their copolymers with esters and amides of acrylic acid and methacrylic acid

e5) copolymers of vinylpyrrolidone with quaternized derivatives of dialkylaminoacrylate and -methacrylate

e6) vinylpyrrolidone-methoimidazolinium chloride copolymers

e7) quaternized polyvinyl alcohol

e8) polymers indicated under the INCI designations Polyquaternium 2, Polyquaternium 17, Polyquaternium 18, and Polyquaternium 27.

Water-soluble polymers in the sense of the invention are those polymers which are soluble to the extent of more than 2.5% by weight at room temperature in water.

The outer coatings of the second part of the detergents of the invention may be prepared from individual polymers of those mentioned above; alternatively, mixtures or multi-layer laminar constructions of the polymers may be used. The polymers are described in more detail below.

Water-soluble polymers which are preferred in accordance with the invention are nonionogenic. Examples of suitable nonionic polymers are the following:

polyvinylpyrrolidones, as marketed, for example, under the designation Luviskol® (BASF). Polyvinylpyrrolidones are preferred nonionic polymers in the context of the invention.

Polyvinylpyrrolidones [poly(1-vinyl-2-pyrrolidin-ones)], abbreviated PVP, are polymers of the general formula (XIII)

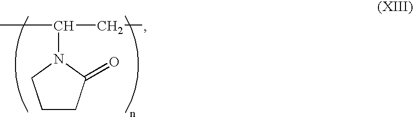

prepared by free-radical addition polymerization of 1-vinylpyrrolidone by processes of solution or suspension polymerization using free-radical initiators (peroxides, azo compounds). The ionic polymerization of the monomer yields only products having low molar masses. Commercially customary polyvinylpyrrolidones have molar masses in the range from approx. 2500-750 000 g/mol, which are characterized by stating the K values and—depending on the K value—have glass transition temperatures of 130-175°. They are supplied as white, hygroscopic powders or as aqueous solutions. Polyvinylpyrrolidones are readily soluble in water and a large number of organic solvents (alcohols, ketones, glacial acetic acid, chlorinated hydrocarbons, phenols, etc.).

Vinylpyrrolidone-vinyl ester copolymers, as marketed for example under the trademark Luviskol® (BASF). Luviskol® VA 64 and Luviskol® VA 73, each vinylpyrrolidone-vinyl acetate copolymers, are particularly preferred nonionic polymers.

The vinyl ester polymers are polymers obtainable from vinyl esters and featuring the grouping of the formula (XIV)

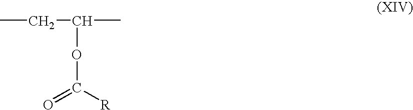

as the characteristic basic structural unit of the macromolecules. Of these, the vinyl acetate polymers (R═CH₃) with polyvinyl acetates, as by far the most important representatives, have the greatest industrial significance.

The vinyl esters are polymerized free-radically by various processes (solution polymerization, suspension polymerization, emulsion polymerization, and bulk polymerization). Copolymers of vinyl acetate with vinylpyrrolidone comprise monomer units of the formulae (XIII) and (XIV)

Cellulose ethers, such as hydroxypropylcellulose, hydroxyethylcellulose and methylhydroxypropyl-cellulose, as marketed for example under the trademarks Culminal® and Benecel® (AQUALON)

Cellulose ethers may be described by the general formula (XV)

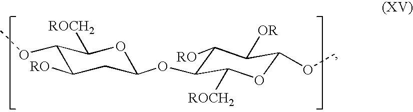

where R is H or an alkyl, alkenyl, alkynyl, aryl, or alkylaryl radical. In preferred products, at least one R in formula (XI) is —CH₂CH₂CH₂—OH or —CH₂CH₂—OH. Cellulose ethers are prepared industrially by etherifying alkali metal cellulose (e.g., with ethylene oxide). Cellulose ethers are characterized by way of the average degree of substitution, DS, and/or by the molar degree of substitution, MS, which indicate how many hydroxyl groups of an anhydroglucose unit of cellulose have reacted with the etherifying reagent or how many moles of the etherifying reagent have been added on, on average, to one anhydroglucose unit. Hydroxyethylcelluloses are water-soluble above a DS of approximately 0.6 and, respectively, an MS of approximately 1. Commercially customary hydroxyethyl- and hydroxypropylcelluloses have degrees of substitution in the range of 0.85-1.35 (DS) and 1.5-3 (MS), respectively. Hydroxyethyl- and -propylcelluloses are marketed as yellowish white, odorless and tasteless powders in greatly varying degrees of polymerization. Hydroxyethyl- and -propylcelluloses are soluble in cold and hot water and in some (water-containing) organic solvents, but insoluble in the majority of (anhydrous) organic solvents; their aqueous solutions are relatively insensitive to changes in pH or addition of electrolyte.

Polyvinyl alcohols, denoted PVALs for short, are polymers of the general structure

[—CH₂—CH(OH)—]ₙ

including small fractions of structural units of the

[—CH₂—CH(OH)—CH(OH)—CH₂]

type. Since the corresponding monomer, the vinyl alcohol, is unstable in free form, polyvinyl alcohols are prepared by way of polymer-analogous reactions by hydrolysis, but industrially in particular by alkalicatalyzed transesterification of polyvinyl acetates with alcohols (preferably methanol) in solution. These industrial processes also make it possible to obtain PVALs having a predeterminable residual fraction of acetate groups.

Commercially customary PVALs (e.g., Mowiol® grades from Hoechst) are commercialized as yellowish white powders or granules having degrees of polymerization in the range of approx. 500-2500 (corresponding to molar masses of approximately 20 000-100 000 g/mol) and have different degrees of hydrolysis of 98-99 or 87-89 mol %. They are, therefore, partially hydrolyzed polyvinyl acetates having a residual acetyl group content of approximately 1-2 or 11-13 mol %.

The water-solubility of PVAL may reduce by after-treatment with aldehydes (acetalization), by complexing with Ni salts or Cu salts, or by treatment with dichromates, boric acid and/or borax, and so adjust in a targeted manner to desired levels.

Further polymers suitable in accordance with the invention are water-soluble amphopolymers. The generic term amphopolymers embraces amphoteric polymers, i.e., polymers whose molecule includes both free amino groups and free —COOH or SO₃H groups and are capable of forming inner salts, zwitterionic polymers whose molecule contains quaternary ammonium groups and —COO—OR—SO₃⁻ groups, and polymers containing —COOH or SO₃H groups and quaternary ammonium groups. An example of an amphopolymer which may be used in accordance with the invention is the acrylic resin obtainable under the designation Amphomer®, which constitutes a copolymer of tert-butylaminoethyl methacrylate, N-(1,1,3,3-tetra-methylbutyl)acrylamide, and two or more monomers from the group consisting of acrylic acid, methacrylic acid and their simple esters. Likewise preferred amphopolymers are composed of unsaturated carboxylic acids (e.g., acrylic and methacrylic acid), cationically derivatized unsaturated carboxylic acids, (e.g., acrylamidopropyltrimethylammonium chloride), and, if desired, further ionic or nonionogenic monomers. Terpolymers of acrylic acid, methyl acrylate and methacrylamidopropyltrimonium chloride, as available commercially under the designation Merquat® 2001 N, are particularly preferred ampho-polymers in accordance with the invention. Further suitable amphoteric polymers are, for example, the octylacrylamide-methyl methacrylate-tert-butylamino-ethyl methacrylate-2-hydroxypropyl methacrylate copolymers available under the designations Amphomer® and Amphomer® LV-71 (DELFT NATIONAL).

Acrylamidopropyltrimethylammonium chloride-acrylic acid or -methacrylic acid copolymers and their alkali metal salts and ammonium salts are preferred zwitterionic polymers. Further suitable zwitterionic polymers are methacryloylethyl betaine-methacrylate copolymers, which are obtainable commercially under the designation Amersette® (AMERCHOL).

Anionic polymers that are suitable in accordance with the invention include:

vinyl acetate-crotonic acid copolymers, as are commercialized, for example, under the designations Resyn® (NATIONAL STARCH), Luviset® (BASF) and Gafset® (GAF).

In addition to monomer units of the above formula (X), these polymers also have monomer units of the general formula (XVI):

[—CH(CH₃)—CH(COOH)—]ₙ (XVI)

Vinylpyrrolidone-vinyl acrylate copolymers, obtainable for example under the trademark Luviflex® (BASF). A preferred polymer is the vinyl-pyrrolidone-acrylate terpolymer obtainable under the designation Luviflex® VBM-35 (BASF)

Acrylic acid-ethyl acrylate-N-tert-butylacrylamide terpolymers, which are marketed for example under the designation Ultrahold® strong (BASF).

Graft polymers of vinyl esters, esters of acrylic acid or methacrylic acid alone or in a mixture, copolymerized with crotonic acid, acrylic acid or methacrylic acid with polyalkylene oxides and/or polyalkylene glycols

Such grafted polymers of vinyl esters, esters of acrylic acid or methacrylic acid alone or in a mixture with other copolymerizable compounds onto polyalkylene glycols are obtained by polymerization under hot conditions in homogeneous phase, by stirring the polyalkylene glycols into the monomers of the vinyl esters, esters of acrylic acid or methacrylic acid, in the presence of free-radical initiators.

Vinyl esters which have been found suitable are, for example, vinyl acetate, vinyl propionate, vinyl butyrate, vinyl benzoate, and esters of acrylic acid or methacrylic acid which have been found suitable are those obtainable with low molecular weight aliphatic alcohols, i.e., in particular, ethanol, propanol, isopropanol, 1-butanol, 2-butanol, 2-methyl-1-propanol, 2-methyl-2-propanol, 1-pentanol, 2-pentanol, 3-pentanol, 2,2-dimethyl-1-propanol, 3-methyl-1-butanol; 3-methyl-2-butanol, 2-methyl-2-butanol, 2-methyl-1-butanol, and 1-hexanol.

Suitable polyalkylene glycols include in particular polyethylene glycols and polypropylene glycols. Polymers of ethylene glycol which satisfy the general formula XVII

H—(O—CH₂—CH₂)ₙ—OH (XVII)

in which n may adopt values between 1 (ethylene glycol) and several thousand. For polyethylene glycols there exist various nomenclatures, which may lead to confusion. It is common in the art to state the average relative molecular weight after the letters “PEG”, so that “PEG 200” characterizes a polyethylene glycol having a relative molar mass of from about 190 to about 210. For cosmetic ingredients, a different nomenclature is used, in which the abbreviation PEG is provided with a hyphen and the hyphen is followed directly by a number which corresponds to the number n in the abovementioned formula V. According to this nomenclature (known as the INCI nomenclature, CTFA International Cosmetic Ingredient Dictionary and Handbook, 5th Edition, The Cosmetic, Toiletry and Fragrance Association, Washington, 1997), for example, PEG-4, PEG-6, PEG-8, PEG-9, PEG-10, PEG-12, PEG-14, and PEG-16 may be used. Polyethylene glycols are available commercially, for example, under the trade names Carbowax® PEG 200 (Union Carbide), Emkapol® 200 (ICI Americas), Lipoxol® 200 MED (HÜLS America), Polyglycol® E-200 (Dow Chemical), Alkapol® PEG 300 (Rhone-Poulenc), Lutrol® E300 (BASF), and the corresponding trade names with higher numbers.

Polypropylene glycols (abbreviation PPGs) are polymers of propylene glycol which satisfy the general formula XVIII

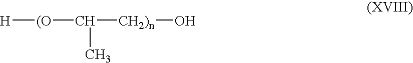

in which n may adopt values between 1 (propylene glycol) and several thousand. Industrially significant in this case are, in particular, di-, tri- and tetrapropylene glycol, i.e., the representatives where n=2, 3 and 4 in formula XVIII.

In particular, it is possible to use the vinyl acetate copolymers grafted onto polyethylene glycols and the polymers of vinyl acetate and crotonic acid grafted onto polyethylene glycols.

Grafted and crosslinked copolymers from the copolymerization of

i) at least one monomer of the nonionic type,

ii) at least one monomer of the ionic type,

iii) polyethylene glycol, and

iv) a crosslinker

The polyethylene glycol used has a molecular weight of between 200 and several million, preferably between 300 and 30 000.

The nonionic monomers may be of very different types and include the following preferred monomers: vinyl acetate, vinyl stearate, vinyl laurate, vinyl propionate, allyl stearate, allyl laurate, diethyl maleate, allyl acetate, methyl methacrylate, cetyl vinyl ether, stearyl vinyl ether, and 1-hexene.

The nonionic monomers may equally be of very different types, among which particular preference is given to the presence in the graft polymers of crotonic acid, allyloxyacetic acid, vinylacetic acid, maleic acid, acrylic acid, and methacrylic acid.

Preferred crosslinkers are ethylene glycol dimethacrylate, diallyl phthalate, ortho-, meta- and paradivinylbenzene, tetraallyloxyethane, and polyallylsaccharoses containing 2 to 5 allyl groups per molecule of saccharin.

The above-described grafted and crosslinked copolymers are formed preferably of:

i) from 5 to 85% by weight of at least one monomer of the nonionic type,

ii) from 3 to 80% by weight of at least one monomer of the ionic type,

iii) from 2 to 50% by weight, preferably from 5 to 30% by weight, of polyethylene glycol, and

iv) from 0.1 to 8% by weight of a crosslinker, the percentage of the crosslinker being shaped by the ratio of the overall weights of i), ii) and iii).

Copolymers obtained by copolymerizing at least one monomer from each of the three following groups:

i) esters of unsaturated alcohols and short-chain saturated carboxylic acids and/or esters of short-chain saturated alcohols and unsaturated carboxylic acids,

ii) unsaturated carboxylic acids,

iii) esters of long-chain carboxylic acids and unsaturated alcohols and/or esters of the carboxylic acids of group ii) with saturated or unsaturated, straight-chain or branched C₈₋₁₈ alcohols

Short-chain carboxylic acids and alcohols here are those having 1 to 8 carbon atoms, it being possible for the carbon chains of these compounds to be interrupted, if desired, by divalent hetero-groups such as —O—, —NH—, and —Sh.

Terpolymers of crotonic acid, vinyl acetate, and an allyl or methallyl ester

These terpolymers contain monomer units of the general formulae (II) and (IV) (see above) and also monomer units of one or more allyl or methallyl esters of the formula XIX:

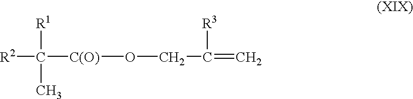

in which R³ is —H or —CH₃, R² is —CH₃ or —CH(CH₃)₂ and R¹ is —CH₃ or a saturated straight-chain or branched C₁₋₆ alkyl radical and the sum of the carbon atoms in the radicals R¹ and R² is preferably 7, 6, 5, 4, 3 or 2.

The abovementioned terpolymers result preferably from the copolymerization of from 7 to 12% by weight of crotonic acid, from 65 to 86% by weight, preferably from 71 to 83% by weight, of vinyl acetate and from 8 to 20% by weight, preferably from 10 to 17% by weight, of allyl or methallyl esters of the formula XIV.

Tetra- and pentapolymers of

i) crotonic acid or allyloxyacetic acid

ii) vinyl acetate or vinyl propionate

iii) branched allyl or methallyl esters

iv) vinyl ethers, vinyl esters or straight-chain allyl or methallyl esters

Crotonic acid copolymers with one or more monomers from the group consisting of ethylene, vinylbenzene, vinyl methyl ether, acrylamide and the water-soluble salts thereof

Terpolymers of vinyl acetate, crotonic acid and vinyl esters of a saturated aliphatic α-branched monocarboxylic acid.

Particularly appropriate outer coating materials for the second part among the anionic polymers are polycarboxylates/polycarboxylic acids, polymeric polycarboxylates, polyaspartic acid, polyacetals, and dextrins, which are described below.

Examples of organic coating materials which may be used are the polycarboxylic acids which may be used in the form of their sodium salts but also in free form. Polymeric polycarboxylates are, for example, the alkali metal salts of polyacrylic acid or of polymethacrylic acid, examples being those having a relative molecular mass of from 500 to 70 000 g/mol.

The molar masses reported for polymeric poly-carboxylates, for the purposes of this document, are weight-average molar masses, M_{w}, of the respective acid form, determined fundamentally by means of gel permeation chromatography (GPC) using a UV detector. Measurement was made against an external polyacrylic acid standard, which owing to its structural similarity to the polymers under investigation provides realistic molar weight values. These figures differ markedly from the molar weight values obtained using polystyrenesulfonic acids as the standard. The molar masses measured against polystyrenesulfonic acids are generally much higher than the molar masses reported in this document.

Suitable polymers are, in particular, polyacrylates, which preferably have a molecular mass of from 2000 to 20 000 g/mol. Owing to their superior solubility, preference in this group may be given in turn to the short-chain polyacrylates, which have molar masses of from 2000 to 10 000 g/mol, and with particular preference from 3000 to 5000 g/mol.

Also suitable are copolymeric polycarboxylates, especially those of acrylic acid with methacrylic acid and of acrylic or methacrylic acid with maleic acid.

Copolymers which have been found particularly suitable are those of acrylic acid with maleic acid, containing from 50 to 90% by weight acrylic acid and from 50 to 10% by weight maleic acid. Their relative molecular mass, based on free acids, is generally from 2000 to 70 000 g/mol, preferably from 20 000 to 50 000 g/mol, and in particular from 30 000 to 40 000 g/mol.

Particular preference as coating materials is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Further preferred copolymeric coating materials are those whose monomers are preferably acrolein and acrylic acid/acrylic salts, and, respectively, acrolein and vinyl acetate.

Similarly, further preferred coating materials that may be mentioned include polymeric amino dicarboxylic acids, their salts or their precursor substances. Particular preference is given to polyaspartic acids and their salts and derivatives.

Further suitable coating materials are polyacetals, which may be obtained by reacting dialdehydes with polyol carboxylic acids having 5 to 7 carbon atoms and at least 3 hydroxyl groups. Preferred polyacetals are obtained from dialdehydes such as glyoxal, glutar-aldehyde, terephthalaldehyde and mixtures thereof and from polyol carboxylic acids such as gluconic acid and/or glucoheptonic acid.

Further polymers which may be used with preference as coating materials are cationic polymers. Among the cationic polymers, the permanently cationic polymers are preferred. “Permanently cationic” refers according to the invention to those polymers which independently of the pH of the composition (i.e., both of the coating layer and of the remaining shaped detergent body) have a cationic group. These are generally polymers which include a quaternary nitrogen atom, in the form of an ammonium group, for example.

Examples of preferred cationic polymers are the following:

Quaternized cellulose derivatives, as are available commercially under the designations Celquat® and Polymer JR®. The compounds Celquat® H 100, Celquat® L 200 and Polymer JR® 400 are preferred quaternized cellulose derivatives.

Polysiloxanes with quaternary groups, such as, for example, the commercially available products Q2-7224 (manufacturer: Dow Corning; a stabilized trimethylsilylamodimethicone), Dow Corning® 929 emulsion (comprising a hydroxyl-amino-modified silicone, also referred to as amodimethicone), SM-2059 (manufacturer: General Electric), SLM-55067 (manufacturer: Wacker), and Abil®-Quat 3270 and 3272 (manufacturer: Th. Goldschmidt; diquaternary polydimethylsiloxanes, Quaternium-80),

Cationic guar derivatives, such as in particular the products marketed under the trade names Cosmedia® Guar and Jaguar®,

Polymeric dimethyldiallylammonium salts and their copolymers with esters and amides of acrylic acid and methacrylic acid. The products available commercially under the designations Merquat® 100 (poly(dimethyldiallylammonium chloride)) and Merquat® 550 (dimethyldiallylammonium chloride-acrylamide copolymer) are examples of such cationic polymers.

Copolymers of vinylpyrrolidone with quaternized derivatives of dialkylamino acrylate and methacrylate, such as, for example, with diethyl sulfate-quaternized vinylpyrrolidone-dimethylamino methacrylate copolymers. Such compounds are available commercially under the designations Gafquat® 734 and Gafquat® 755.

Vinylpyrrolidone-methoimidazolinium chloride copolymers, as offered under the designation Luviquat®.

Quaternized polyvinyl alcohol

and also the polymers known under the designations

Polyquaternium 2,

Polyquaternium 17,

Polyquaternium 18, and

Polyquaternium 27,

having quaternary nitrogen atoms in the polymer main chain. These polymers are designated in accordance with the INCI nomenclature; detailed information can be found in the CTFA International Cosmetic Ingredient Dictionary and Handbook, 5th Edition, The Cosmetic, Toiletry and Fragrance Association, Washington, 1997, which is expressly incorporated herein by reference.

Cationic polymers which are preferred in accordance with the invention are quaternized cellulose derivatives and also polymeric dimethyldiallylammonium salts and copolymers thereof. Cationic cellulose derivatives, especially the commercial product Polymers JR 400, are especially preferred cationic polymers.

As coating materials it is likewise possible to use, with preference, carboxylic or dicarboxylic acids, respectively those having an even number of carbon atoms. Particularly preferred carboxylic or dicarboxylic acids are those having at least 4, preferably having at least 6, with particular preference having at least 8, and in particular those having from 8 to 13, carbon atoms. Particularly preferred dicarboxylic acids are, for example, adipic acid, pimelic acid, suberic acid, azelaic acid, sebacic acid, undecanoic acid, dodecanoic acid, brassylic acid and mixtures thereof. Also suitable coating materials, however, are tetradecanoic acid, pentadecanoic acid, and thapsic acid. Particularly preferred carboxylic acids are those having from 12 to 22 carbon atoms, with those having from 18 to 22 carbon atoms being particularly preferred. The use of the disintegration assistants described earlier on above is particularly advisable in the case of acid coating layers, typical use concentrations for the disintegration assistants in the coating layers being from 0.1 to 5% by weight, based on the coating layer.

The second part of the detergents of the invention may be present in the form of granules and/or agglomerates, pellets, extrudates, tablets or capsules, preferred second-part embodiments being those having a defined size. In this context, preference is given to detergents of the invention wherein the second part has a diameter of between 1 and 30 mm, preferably between 2.5 and 15 mm, and in particular between 5 and 10 mm. The term “diameter” applies, strictly speaking, only to spherical second parts, since only these possess a single diameter. Where the second part is of another shape—for example, cylindrical, ellipsoidal, cuboid or cubic, etc., the remark above applies to the size (area) diameter.

As already mentioned, the second part may be produced by all customary techniques. In the case of bodies which are preferred in the context of the present invention, having volumes of between 0.1 and 10 cm³, preferably between 0.25 and 7.5 cm³, and in particular between 0.5 and 5 cm³, preference is given to production by casting techniques, by sintering, by extrusion, by calendering or by tableting. In the light of the ingredients of the second part, particular preference is given to detergents wherein the second part has been produced by a pressing operation, especially tableting.

Irrespective of how the second coated part is formulated, it may be combined with a first part of any desired design. The first part may be present in the form, for example, of a detergent powder or a compact shaped body. Given an appropriate design, liquid or gellike first parts are realizable, but owing to the sedimentation and stability problem of the second parts in such a matrix are less preferred.

Before the description of the possibilities for the design of the first part and of the finished detergent composed of both parts, there now follows a description of the ingredients which may be present in the first part. All of the substances referred to below may also, in whole or in part, be constituents of the second part.

Builders have already been described earlier on above as a possible constituent of the second part. In preferred embodiments of the invention they are also present in the first part, preference being given to detergents wherein the first part contains builders in amounts of from 1 to 100% by weight, preferably from 5 to 95% by weight, with particular preference from 10 to 90% by weight, and in particular from 20 to 85% by weight, based in each case on the weight of the first part.

Particular preference is given in this context to detergents of the invention wherein the first part contains phosphate(s), preferably alkali metal phosphate(s), with particular preference pentasodium and/or pentapotassium triphosphate (sodium and/or potassium tripolyphosphate), in amounts of from 20 to 80% by weight, preferably from 25 to 75% by weight, in particular from 30 to 70% by weight, based in each case on the weight of the first part.

Besides the phosphates, the citrates in particular are preferred builder substances. Accordingly, detergents of the invention wherein the first part contains citrate(s), preferably sodium citrate, with particular preference trisodium citrate dihydrate, in amounts of from 10 to 60% by weight, preferably from 15 to 50% by weight, and in particular from 20 to 40% by weight, based in each case on the weight of the first part, are likewise preferred embodiments of the present invention.

Nonionic surfactants have also already been described in detail earlier on above. They may likewise be a constituent of the first part, their amount in the first part usually lying within the range from 0.5 to 5% by weight, preferably between 1 and 2% by weight. Where formulations are to be provided in which the first part provides for the “built-in rinse aid”, then higher amounts of surfactant are possible; for further details, see below.

Detergents of one of claims 1 to 17, characterized in that the first part comprises bleaches from the group of the oxygen or halogen bleaches, especially the chlorine bleaches, with particular preference sodium perborate and sodium percarbonate, in amounts of from 2 to 25% by weight, preferably from 5 to 20% by weight, and in particular from 10 to 15% by weight, based in each case on the weight of the first part.

Besides the builders, important ingredients of detergents include in particular substances from the groups of the surfactants (see above), bleaches, bleach activators, enzymes, polymers, dyes, and fragrances.

Important representatives from said classes of substance are described below.

Among the compounds used as bleaches which yield H₂O₂ in water, particular importance is possessed by sodium perborate tetrahydrate and sodium perborate mono-hydrate. Examples of further bleaches which may be used are sodium percarbonate, peroxy pyrophosphates, citrate perhydrates, and also H₂O₂-donating peracidic salts or peracids, such as perbenzoates, peroxophthalates, diperazelaic acid, phthaloimino peracid, or diper-dodecanedioic acid. Detergents of the invention may also comprise bleaches from the group of organic bleaches. Typical organic bleaches are the diacyl peroxides, such as dibenzoyl peroxide, for example. Further typical organic bleaches are the peroxy acids, particular examples being the alkyl peroxy acids and the aryl peroxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxy caproic acid [phthaloiminoperoxy-hexanoic acid (PAP)], o-carboxybenzamidoperoxycaproic acid, N-nonenylamidoperadipic acid and N-nonenylamido-persuccinates, and (c) aliphatic and araliphatic peroxy dicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid and N,N-terephthaloyldi(6-aminopercaproic acid) may also be used.

Bleaches used in the detergents of the invention for machine dishwashing may also be substances which release chlorine or bromine. Among the suitable chlorine- or bromine-releasing materials examples include heterocyclic N-bromoamides and N-chloroamides, examples being trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

Preference is given to detergents of the invention wherein the first part contains bleach activators from the groups of polyacylated alkylenediamines, especially tetraacetylethylenediamine (TAED), N-acyl imides, especially N-nonanoylsuccinimide (NOSI), acylated phenolsulfonates, especially n-nonanoyl- or isononanoyloxybenzenesulfonate (n- or iso-NOBS), and n-methylmorpholiniumacetonitrile methyl sulfate (MMA), in amounts of from 0.25 to 15% by weight, preferably from 0.5 to 10% by weight, and in particular from 1 to 5% by weight, based in each case on the weight of the first part.

In order to achieve an “after-bleaching” effect in the rinse cycle, the abovementioned bleaches may also be introduced into the machine dishwashing detergents of the invention in whole or in part by way of the second part.

Bleach activators, which boost the action of the bleaches, may be a constituent of both the first and second parts. Known bleach activators are compounds containing one or more N-acyl and/or O-acyl groups, such as substances from the class of the anhydrides, esters, imides and acylated imidazoles or oximes. Examples are tetraacetylethylenediamine TAED, tetra-acetylmethylenediamine TAMD, and tetraacetyl-hexylenediamine TAHD, and also pentaacetylglucose PAG, 1,5-diacetyl-2,2-dioxohexahydro-1,3,5-triazine DADHT, and isatoic anhydride ISA.

Bleach activators which may be used are compounds which under perhydrolysis conditions give rise to aliphatic peroxocarboxylic acids having preferably 1 to 10 carbon atoms, in particular 2 to 4 carbon atoms, and/or substituted or unsubstituted perbenzoic acid. Suitable substances are those which carry O-acyl and/or N-acyl groups of the stated number of carbon atoms, and/or substituted or unsubstituted benzoyl groups. Preference is given to polyacylated alkylenediamines, especially tetraacetylethylenediamine (TAED), acylated triazine derivatives, especially 1,5-diacetyl-2,4-dioxohexa-hydro-1,3,5-triazine (DADHT), acylated glycolurils, especially tetraacetylglycoluril (TAGU), N-acylimides, especially N-nonanoylsuccinimide (NOSI), acylated phenolsulfonates, especially n-nonanoyl- or iso-nonanoyloxybenzenesulfonate (n- or iso-NOBS), carboxylic anhydrides, especially phthalic anhydride, acylated polyhydric alcohols, especially triacetin, ethylene glycol diacetate, 2,5-diacetoxy-2,5-dihydro-furan, n-methylmorpholiniumacetonitrile methyl sulfate (MMA), acetylated sorbitol and mannitol and/or mixtures thereof (SORMAN), acylated sugar derivatives, especially pentaacetylglucose (PAG), pentaacetylfructose, tetraacetylxylose and octaacetyllactose, and acetylated, optionally N-alkylated glucamine and gluconolactone, and/or N-acylated lactams, for example, N-benzoylcaprolactam. Hydrophilically substituted acylacetals and acyllactams are likewise used with preference. Combinations of conventional bleach activators may also be used.

In addition to the conventional bleach activators, or instead of them, it is also possible to incorporate what are known as bleaching catalysts into the detergents. These substances are bleach-boosting transition metal salts or transition metal complexes such as, for example, Mn-, Fe-, Co-, Ru- or Mo-salen complexes or -carbonyl complexes. Other bleaching catalysts which can be used include Mn, Fe, Co, Ru, Mo, Ti, V and Cu complexes with N-containing tripod ligands, and also Co-, Fe-, Cu- and Ru-ammine complexes.

Preference is given to the use of bleach activators from the group of polyacylated alkylenediamines, especially tetraacetylethylenediamine (TAED), N-acyl imides, especially N-nonanoylsuccinimide (NOSI), acylated phenolsulfonates, especially n-nonanoyl- or isononanoyloxybenzenesulfonate (n- or iso-NOBS), n-methylmorpholiniumacetonitrile methyl sulfate (MMA), preferably in amounts of up to 10% by weight, in particular from 0.1% by weight to 8% by weight, more particularly from 2 to 8% by weight, and with particular preference from 2 to 6% by weight, based on the overall composition.

Bleach-boosting transition metal complexes, especially those with the central atoms Mn, Fe, Co, Cu, Mo, V, Ti and/or Ru, preferably selected from the group of manganese and/or cobalt salts and/or complexes, with particular preference from cobalt ammine complexes, cobalt acetato complexes, cobalt carbonyl complexes, the chlorides of cobalt or manganese, and manganese sulfate, are used in customary amounts, preferably in an amount of up to 5% by weight, in particular from 0.0025% by weight to 1% by weight, and with particular preference from 0.01% by weight to 0.25% by weight, based in each case on the overall composition. In specific cases, however, it is also possible to use a greater amount of bleach activator.

Further ingredients may also be constituents of the first and/or second part. Here, preference is given to detergents wherein the first part further contains one or more substances from the groups of enzymes, corrosion inhibitors, scale inhibitors, cobuilders, dyes and/or fragrances in total amounts of from 6 to 30% by weight, preferably from 7.5 to 25% by weight, and in particular from 10 to 20% by weight, based in each case on the weight of the first part.

Further-preferred detergents are characterized in that the first part contains silver protectants from the group consisting of triazoles, benzotriazoles, bisbenzotriazoles, aminotriazoles, alkylaminotriazoles, and transition metal salts or transition metal complexes, with particular preference benzotriazole and/or alkylaminotriazole, in amounts of from 0.01 to 5% by weight, preferably from 0.05 to 4% by weight, and in particular from 0.5 to 3% by weight, based in each case on the weight of the first part.

The first or second part may include said corrosion inhibitors for protecting the ware or the machine, with special importance in the field of machine dishwashing being possessed, in particular, by silver protectants. The known substances of the prior art may be used. In general it is possible to use, in particular, silver protectants selected from the group consisting of triazoles, benzotriazoles, bisbenzotriazoles, amino-triazoles, alkylaminotriazoles, and transition metal salts or transition metal complexes. Particular preference is given to the use of benzotriazole and/or alkylaminotriazole. Frequently encountered in cleaning formulations, furthermore, are agents containing active chlorine, which may significantly reduce corrosion of the silver surface. In chlorine-free cleaners, use is made in particular of oxygen-containing and nitrogen-containing organic redox-active compounds, such as divalent and trivalent phenols, e.g. hydroquinone, pyrocatechol, hydroxyhydroquinone, gallic acid, phloroglucinol, pyrogallol, and derivatives of these classes of compound. Inorganic compounds in the form of salts and complexes, such as salts of the metals Mn, Ti, Zr, Hf, V, Co and Ce, also find frequent application. Preference is given in this context to the transition metal salts selected from the group consisting of manganese and/or cobalt salts and/or complexes, with particular preference cobalt ammine complexes, cobalt acetato complexes, cobalt carbonyl complexes, the chlorides of cobalt or of manganese and manganese sulfate. Similarly, zinc compounds may be used to prevent corrosion on the ware.

Suitable enzymes in the detergents of the invention include in particular those from the classes of the hydrolases such as the proteases, esterases, lipases or lipolytic enzymes, amylases, glycosyl hydrolases, and mixtures of said enzymes. All of these hydrolases contribute to removing stains, such as proteinaceous, fatty or starchy marks. For bleaching, it is also possible to use oxidoreductases. Especially suitable enzymatic active substances are those obtained from bacterial strains or fungi such as Bacillus subtilis, Bacillus licheniformis, Streptomyceus griseus, Coprinus cinereus and Humicola insolens, and also from genetically modified variants thereof. Preference is given to the use of proteases of the subtilisin type, and especially of proteases obtained from Bacillus lentus. Of particular interest in this context are enzyme mixtures, examples being those of protease and amylase or protease and lipase or lipolytic enzymes, or of protease, amylase and lipase or lipolytic enzymes, or protease, lipase or lipolytic enzymes, but especially protease and/or lipase-containing mixtures or mixtures with lipolytic enzymes. Examples of such lipolytic enzymes are the known cutinases. Peroxidases or oxidases have also proven suitable in some cases. The suitable amylases include, in particular, alpha-amylases, iso-amylases, pullulanases, and pectinases.

The enzymes may be adsorbed on carrier substances or embedded in coating substances in order to protect them against premature decomposition. The proportion of the enzymes, enzyme mixtures or enzyme granules may be, for example, from about 0.1 to 5% by weight, preferably from 0.5 to about 4.5% by weight.

Dyes and fragrances may be added to the machine dishwashing detergents of the invention in order to enhance the esthetic appeal of the products which are formed and to provide the consumer with not only the performance but also a visually and sensorially “typical and unmistakable” product. As perfume oils and/or fragrances it is possible to use individual odorant compounds, examples being the synthetic products of the ester, ether, aldehyde, ketone, alcohol, and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate, and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol, and terpineol; the hydrocarbons include primarily the terpenes such as limonene and pinene. Preference, however, is given to the use of mixtures of different odorants, which together produce an appealing fragrance note. Such perfume oils may also contain natural odorant mixtures, as obtainable from plant sources, examples being pine oil, citrus oil, jasmine oil, patchouli oil, rose oil or ylang-ylang oil. Likewise suitable are muscatel, sage oil, camomile oil, clove oil, balm oil, mint oil, cinnamon leaf oil, lime blossom oil, juniperberry oil, vetiver oil, olibanum oil, galbanum oil and labdanum oil, and also orange blossom oil, neroliol, orange peel oil, and sandalwood oil.

The fragrances may be incorporated directly into the detergents of the invention; alternatively, it may be advantageous to apply the fragrances to carriers, which strengthen the adherence of the perfume to the laundry and, by slowing the release of fragrance, provide for long-lasting fragrance of the textiles. Materials which have become established as such carriers are, for example, cyclodextrins, it being possible in addition for the cyclodextrin-perfume complexes to be additionally coated with further auxiliaries. Incorporating the fragrances into the second part is also possible, and results in a fragrance sensation when the machine is opened, since the fragrances are released only in the rinse cycle.

It is preferred to separate corrosion protectants from the bleaches, for example, by virtue of substances of one group being present in the first part and those of the other group being present in the second part. Naturally it is also possible to configure the first part in multiphase form and to separate the substances from one another within the first part.

Separating the bleaches from other ingredients may also be advantageous. Detergents of the invention wherein one part comprises bleaches while another comprises enzymes are likewise preferred. Preference is also given to detergents wherein one part comprises bleaches while another comprises bleach activators. Here again it is naturally possible to configure the first part in multiphase form and to separate the substances from one another within the first part.

As already mentioned, the first part may be either liquid, gellike or pastelike or else solid and in that case in particular pulverulent or provided in the form of a compact shaped body. In a sequence of ascending preference, preferred detergents of the invention are those wherein the first part is a liquid, gellike or pastelike composition for machine dishwashing. Particularly preferred detergents are those wherein the first part is a particulate composition for machine dishwashing.

Particular preference is given to detergents of the invention wherein the first part is a machine dishwashing composition in tablet form.

This tablet-form composition of the first part of the detergents of the invention is described by the term “base tablet” and, in the context of the present invention, characterizes the tablet produced by conventional tableting operations. In preferred embodiments of the present invention the base tablet is produced first and the coated second part is applied to or inserted into this base tablet in a further workstep. The resulting product is referred to below by the generic term “tablet”.

The base tablet may take on any geometric form whatsoever, with particular preference being given to concave, convex, biconcave, biconvex, cubic, tetragonal, orthorhombic, cylindrical, spherical, cylinder-segmentlike, discoid, tetrahedral, dodecahedral, octahedral, conical, pyramidal, ellipsoid, pentagonal-, heptagonal- and octagonal-prismatic, and rhombohedral forms. It is also possible to realize completely irregular outlines such as arrow or animal forms, trees, clouds, etc. If the base tablet has corners and edges, these are preferably rounded off. As an additional visual differentiation, an embodiment having rounded corners and beveled (chamfered) edges is preferred.

Preferred base tablets have two or more phases which allow separation of incompatible ingredients. Accordingly, preference is given to detergents of the invention which are characterized in that the first part is a multiphase tablet, in particular a two-, three- or four-phase tablet, the phases preferably having the form of layers.

Such tablets may be formulated to give the finished detergent of the invention by comprising the second coated part in the form of a further layer. Naturally, the second part may also have a different shape, for example, that of a hemisphere, which is bonded adhesively to one area of the base tablet. Since the easiest bodies to coat are spherical bodies or bodies as similar as possible to the spherical form, it is preferred to adapt the form of the first part to the preferred form of the second part and to provide the first part with a cavity into which the second part is inserted and, where appropriate, fixed. These detergents, wherein the coated second part has the form of a further layer, of a core or of a body adhered on or in the first part (“basic tablet”), are preferred in accordance with the invention, particular preference being given to detergents wherein the first part has (a) cavity(ies) in which the second and any further parts is/are present.

The form of the cavity(ies) may also be chosen freely within wide limits. For reasons of process economy, continuous holes whose openings are located on opposite faces of the tablets, and depressions having an opening at one tablet side, have become established. In preferred base tablets, the cavity has the form of a continuous hole whose openings are located on two opposite tablet surfaces. The form of a continuous hole of this kind may be chosen freely, preference being given to tablets wherein the continuous hole has circular, ellipsoid, triangular, rectangular, square, pentagonal, hexagonal, heptagonal or octagonal horizontal sections. It is also possible to realize completely irregular hole shapes, such as arrow or animal forms, trees, clouds, etc. As with the tablets, preference is given, in the case of angular holes, to those having rounded corners and edges or having rounded corners and chamfered edges.

The abovementioned geometric embodiments may be combined with one another as desired. For instance, it is just as possible to prepare tablets having a rectangular or square outline and circular holes as it is to prepare circular tablets having octagonal holes, there being no limits on the diversity of possible combinations. For reasons of process economy and the esthetic perception of the user, particularly preferred hole-type tablets are those wherein the tablet outline and the hole cross section have the same geometric shape, examples being tablets having a square outline and a square hole made centrally therein. Particular preference is given in this context to annular tablets, i.e., circular tablets with a circular hole.

If the aforementioned principle of the hole open at two opposite tablet sides is reduced to an opening, depression tablets are obtained. Detergents of the invention wherein the cavity in the base tablet has the form of a depression are likewise preferred. With this embodiment as well, as with the “hole tablets”, the tablets may take on any geometric form whatsoever, with particular preference being given to concave, convex, biconcave, biconvex, cubic, tetragonal, orthorhombic, cylindrical, spherical, cylinder-segmentlike, discoid, tetrahedral, dodecahedral, octahedral, conical, pyramidal, ellipsoid, pentagonal-, heptagonal- and octagonal-prismatic, and rhombohedral forms. It is also possible to realize completely irregular outlines such as arrow or animal forms, trees, clouds, etc. If the tablet has corners and edges, these are preferably rounded off. As additional visual differentiation, an embodiment having rounded corners and beveled (chamfered) edges is preferred.

The form of the depression may also be chosen freely, preference being given to tablets in which at least one depression may take on a concave, convex, cubic, tetragonal, orthorhombic, cylindrical, spherical, cylinder-segmentlike, discoid, tetrahedral, dodecahedral, octahedral, conical, pyramidal, ellipsoid, pentagonal-, heptagonal- and octagonal-prismatic, or rhombohedral form. It is also possible to realize completely irregular depression forms, such as arrow or animal forms, trees, clouds, etc. As with the tablets, depressions having rounded corners and edges or having rounded corners and chamfered edges are preferred.

The size of the depression or continuous hole in comparison to the total tablet is guided by the desired end use of the Cablets and by the size of the second part to be inserted into the cavity. Depending on whether a smaller or larger amount of active substance is to be present, the size of the cavity may vary. Irrespective of the end use, in preferred detergents the volume ratio of base tablet to cavity is from 2:1 to 100:1, preferably from 3:1 to 80:1, with particular preference from 4:1 to 50:1, and in particular from 5:1 to 30:1.

Similar remarks can be made in relation to the surface fractions accounted for by the tablet with the cavity (“base tablet”), or the aperture area of the cavity as a proportion of the total surface area of the tablet. Preference is given here to tablets wherein the area of the aperture(s) of the cavity(ies) accounts for from 1 to 25%, preferably from 2 to 20%, with particular preference from 3 to 15%, and in particular from 4 to 10% of the total surface area of the tablet.

The present invention is naturally not restricted to combining a first part with merely one second part. Particularly in the case of the embodiment of the tablet with cavity it is possible and preferred to provide a base tablet comprising two or more cavities containing inserted further parts. These inserted further parts (called “cores” below) may be all “second parts” in the sense of the present invention; in other words, may have a suitable coating and may comprise the stated ingredients. It is, however, also possible to produce a tablet having, for example, two cavities (“base tablet”=first part), one of whose cavities is filled with a “second part” in the sense of the present invention while the second cavity contains a different core, for example, an additional “rinse-aid core” comprising surfactant formulated with retarded dissolution, or a quick-dissolving prewash phase comprising dissolution-acceleratedly formulated enzyme and/or bleach. Corresponding detergents wherein the first part comprises at least two cavities one of which contains the second part while the other contains a further, functionalized part are preferred in accordance with the invention.

As already mentioned, it is also possible in accordance with the invention to provide tablets which further comprise a prewash phase. In addition to the stated example of the three-part tablet with different solubilities, this embodiment may also be realized by the form of the application: a basic tablet comprising a “second part” in the sense of the present invention can be provided with a notch. The user can then break off part of the tablet along the notch and place it in the cutlery basket, while the remainder of the tablet is placed in a dosing cassette. The broken-off part, whose composition may be the same as that of the basic tablet or different from it, develops its effect in the prewash cycle, while the remainder is not employed until the main wash cycle, by way of the dosing compartment. Through the choice of an outercoating over the functional coating, the “second part” in the sense of the present invention may both be a constituent of the broken-off part and also of the other part of such a tablet.

Naturally, first and second parts (and any further parts) of the detergents of the invention need not necessarily be formulated as a compact tablet, even if this is preferable for the user for reasons of handling convenience. It is additionally possible, for example, to produce a first and a second part (and any further parts) separately and to package them together in a water-soluble film pouch which the user places into the machine. Irrespective of the nature of formulation, the second part, by virtue of the coating, develops its effect substantially in the rinse cycle of the dishwasher.

As mentioned earlier on above, it is particularly preferred to provide compositions which not only spare the user from dosing regenerating salt but also already contain the rinse aid. This can be done by incorporating surfactant(s) into the second part (see above). Another way consists in incorporating the surfactants into the first part, which in this case is advantageously in solid form, i.e., as powder or tablet.

Accordingly, preference is given to detergents of the invention which are characterized in that the nonionic surfactant content of the first part is from 5 to 25% by weight, based in each case on the first part. With inventive compositions of this embodiment, the amounts of surfactants remaining in the machine after the main wash cycle and the intermediate wash cycles bring about an adequate runoff behavior in the rinse cycle, so that the water running off from the ware leaves no marks on drying. When these inventive compositions are employed, there is no need for the rinse cycle to be charged with additional rinse agents added deliberately.

The production of powders or granules of relatively high surfactant content may take place, for example, by customary granulating techniques. For this purpose, carrier materials are charged to a mixer and the surfactant(s) is (are) mixed with/granulated onto them; in the case where two or more surfactants are used, they can be added either together or in succession. Where finely divided material is added as well (by powdering), the powder properties of the granules may be further significantly improved. As powdering agents it is possible to use the known, prior art substances; in the context of the present invention, disilicates in particular have proven to be particularly advantageous. Also suitable, however, are other finely divided substances, such as sodium carbonate or phosphate, or overdried waterglasses, ground detergent ingredients, etc.

It is particularly preferred in the context of the present invention to granulate carrier materials such as zeolites, sodium carbonate, sodium tripolyphosphate, maltodextrins, polyvinyl alcohols, starch and/or its derivatives and cellulose and/or its derivatives, with the addition of the nonionic surfactants characterized above as preferred, and then to spray the granules conventionally with a sodium silicate solution in order to achieve an at least partial coating of the granule particles. Instead of the silicate solution it is also possible with advantage to use a solution of polyvinyl alcohol. Following production, the granule grains may be dried conventionally (advantageously by fluid-bed drying) and, where appropriate, further “powdered” with finely divided substances such as zeolite and/or silicas. The high surfactant content granules may then be processed conventionally with further components (bleaches, enzymes, etc.) to give detergents.

The coated second parts may be added directly to these pulverulent detergents to give a particulate detergent of the invention. By virtue of their coating, the coated second parts in such machine dishwashing detergents of the invention are formulated so that they dissolve to aminor extent, if at all, in the main wash cycle (and also in optional prewash cycles). This ensures that the active substances are not released until the rinse cycle, where they develop their effect. In addition to this chemical formulation, a physical formulation may be necessary depending on the type of dishwasher, so that the coated second parts are not pumped off when the water is changed in the machine and hence are no longer available for the rinse cycle. Customary household dishwashing machines, upstream of the detergent-liquor pump, which pumps the water or cleaning solution from the machine after the individual cleaning cycles, comprise a sieve insert, intended to prevent clogging of the pump by food residues. If the user cleans heavily soiled kitchen- and tableware, then this sieve insert requires regular cleaning, which is a simple operation owing to the ease of access and removability. The coated second parts in the detergents of the invention, then, are preferably designed in terms of their size and shape such that they do not pass through the sieve insert of the dishwasher even after the cleaning cycle, i.e., after exposure to agitation in the machine and to the detergent solution. This ensures that coated second parts are present in the dishwasher in the rinse cycle, these parts releasing the active substance(s) under the action of the water running into the rinse cycle and so bringing the desired clear-rinse effect. Machine dishwashing detergents that are preferred in the context of the present invention are characterized in that the coated second parts have particle sizes of between 1 and 20 mm, preferably between 1.5 and 15 mm, and in particular between 2 and 12 mm.

In the dishwashing detergents of the invention, the coated second parts, having the sizes stated above, may project from the matrix of the other particulate ingredients; alternatively, the other particles may likewise have sizes within the stated range, so that, overall, a detergent is formulated that comprises large detergent particles and coated second parts. Especially if the coated second parts are colored, i.e., have a red, blue, green, or yellow color, for example, it is advantageous for the appearance of the product, i.e., of the overall detergent, if the coated second parts are visibly larger than the matrix comprising the particles of the other ingredients of the detergent. Here, preference is given to inventive machine dishwashing detergents which have particle sizes (without taking into account the coated second parts) of between 200 and 3000 μm, preferably between 300 and 2500 μm, and in particular between 400 and 2000 μm.

As well as by coloring the coated second parts, the visual attractiveness of such compositions may also be enhanced by contrasting coloration of the powder matrix or by the shape of the coated second parts. Since it is possible to use technically uncomplicated techniques to produce the coated second parts, it is readily possible to offer them in a wide variety of shapes. In addition to the particle shape which approximates to the spherical form, for example, cylindrical or cuboid particles may be produced and used. Other geometric shapes as well may be realized. Specific product designs may include, for example, star-shaped rinse aid particles. It is also possible without problems to produce disks and shapes with plants and animal bodies as their base, examples being tree, flower, blossom, sheep, fish, etc. Interesting visual attractions may also be created in this way by producing the coated second parts in the form of a stylized glass, in order to underscore visually the clear-rinse effect in the product as well. No limits are placed on the imagination in this context.

If the detergents of the invention are formulated as a powder mixture, then—especially if there are large differences between the size of coated second parts and detergent matrix—on the one hand partial separation may occur when the pack is shaken, and on the other hand dosing may be different in two successive washing operations, since the user does not always automatically dose equal quantities of the detergent and coated second parts. If it is desired technically to use an identical quantity for each washing operation, this can be realized by the packaging—familiar to the skilled worker—of the compositions of the invention in water-soluble film pouches. The present invention also provides particulate machine dishwashing detergents wherein one dose unit is welded in a water-soluble film pouch.

By this means, the user need only insert a pouch, containing for example a detergent powder and a plurality of visually distinctive coated second parts, into the dosing compartment of his or her dishwasher. This embodiment of the present invention is therefore a visually attractive alternative to conventional detergent tablets.

The desired retention, described earlier on above, of the coated second parts in the machine even when the water is changed may be effected not only by the abovementioned enlargement of the rinse aid particles but also by a reduction in the size of the holes in the sieve insert. In this way, it is possible to formulate machine dishwashing detergents having a uniform average particle size of less than, for example, from 4 to 12 mm. For this purpose, a sieve insert which replaces or covers the insert present in the machine is added to the product of the invention wherein the coated second parts also have relatively small particle sizes. The present invention therefore additionally provides a kit of parts comprising a pulverulent machine dishwashing detergent of the invention and a sieve insert for domestic dishwashers.

As already mentioned, the inventive combination of composition and sieve insert makes it possible to formulate compositions in which the coated second parts also have relatively small particle sizes. Kits of parts in accordance with the invention wherein the particle sizes of the machine dishwashing detergent (taking into account the coated second parts) are in the range from 400 to 2500 μm, preferably from 500 to 1600 μm, and in particular from 600 to 1200 μm, are preferred.

In order to prevent clogging of the added sieve insert by residues of soil, the chosen mesh size or hole size should not be too small. Here, preference is given to kits of parts in accordance with the invention wherein the mesh size or hole size of the sieve insert is from 1 to 4 mm and the coated second parts are larger than this mesh size or hole size of the sieve insert.

The kit of parts in accordance with the invention is not restricted to the particular form of the sieve insert in which said insert replaces or covers the insert present in the machine. In accordance with the invention it is also possible, and preferred, to enclose with the kit of parts a sieve insert having the form of a basket, which may be suspended in a known manner in the dishwasher—on the cutlery basket, for example. In this way, a sieve insert thus designed replaces the dosing compartment, i.e., the user doses the machine dishwashing detergent of the invention directly into this sieve insert, which acts in the manner described above in the cleaning cycle and rinse cycle.

The detergents of the invention with a high surfactant content in the first part can also be produced in the form of tablets. At its most simple this is done by tableting the aforementioned pulverulent detergents. The coated second part—as already described earlier on above—can subsequently be adhered to the tablet, or adhesively bonded or inserted into a preprepared cavity in the base tablet.

In the context of the present invention it is preferred, however, not to compress the complete above-described pulverulent detergents to form a tablet but instead to produce multiphase basic tablets having a surfactant-rich phase. In this way, active substances which are incompatible can be separated from one another in the at least two-phase basic tablet. It is particularly preferred to compress the high-surfactant-content granules described earlier on above, comprising carrier material, surfactant, and, where appropriate, coating material and/or powdering agent, to form a surfactant-rich tablet phase.

Preferred two-phase base tablets contain, for example, a phase which in addition to up to 30%, preferably up to 20%, and in particular up to 15% by weight of surfactants (based on the phase) comprise phosphate, sodium carbonate, silicate, and bleach, while a second phase comprises enzymes, bleach activators, silver protectants, and dyes, and also up to 20%, preferably up to 10%, and in particular up to 5% by weight (based on the phase) of surfactant. Such two-phase tablets can then be joined to the coated second part to give detergents of the invention in tablet form.

The compression of such surfactant-rich powders to form tablets may lead to technical difficulties, since owing to the high surfactant content these powders tend toward clumping and/or may have poor free-flow properties. Additionally, under the pressure load of the pressing operation, the surfactant may be released (“squeezed out”), leading to instances of caking on the punch. To solve such problems, where they occur, customary solutions are available from the prior art, with particular significance attaching to the use of rotating punches.

Another effective measure is to use plastic inserts or attachments in the tableting punches. Plastic attachments come into direct contact with the die walls during compression, and are normally manufactured on polyamide. Plastic inserts are inserted into tableting punches with a faceted edge, and reduce the risk of caking on the pressing surface.

A further possibility is to arrange the surfactant-rich premix in the center of a three-layer tablet. In this case the upper and lower layers can be formulated so that no caking problems occur.

Summarizing, multiphase embodiments for a surfactant-rich basic tablet, i.e., detergents, are preferred which are characterized in that the first part or at least one phase of a multiphase first part has a nonionic surfactant content of between 5 and 25% by weight, based in each case on the first part or on the phase of the first part, respectively.

The present invention further provides a process for producing detergents for machine dishwashing, which comprises the steps of

A) producing a body which comprises one or more substances from the group consisting of builders, acidifiers, chelating agents or scale inhibiting polymers,

B) coating the body produced in step A),

C) unifying the coated body with a composition which develops its effect substantially in the main cleaning cycle of the dishwasher.

In step A) the body referred to above as “second part” is produced, and is coated in step B) and in step C) is unified with a composition (“base composition” or “base tablet”) to give the finished detergent of the invention.

As already mentioned, the second part can be produced by casting, strand pressing, granulating, extrusion, pelletizing, sintering, foaming, etc. Particularly preferred second parts are tableted products which on the basis of their compact structure can be coated in a particularly effective way, given an appropriate shape. Processes of the invention wherein the producing in step A) takes place by tableting are therefore particularly preferred.

The tableting of the “second part” in step A) proceeds in analogy to the tableting of a base tablet as an option for step C), it having proven advantageous if the premix compressed to form “second parts” or base tablets satisfies certain physical criteria. Preferred processes are characterized, for example, in that particulate premixes for compression has a bulk density of at least 500 g/l, preferably at least 600 g/l, and in particular at least 700 g/l.

The particle size of the premix which is compressed to form “second parts” or base tablets also satisfies, preferably, certain criteria: processes wherein particulate premixes have particle sizes of between 100 and 2000 μm, preferably between 200 and 1800 μm, with particular preference between 400 and 1600 μm, and in particular between 600 and 1400 μm are preferred in accordance with the invention. A further-narrowed particle size in the premixes for compression may be adjusted in order to obtain advantageous tablet properties. In preferred variants of the process of the invention, particulate premixes for compression have a particle size distribution in which less than 10% by weight, preferably less than 7.5% by weight, and in particular less than 5% by weight of the particles are larger than 1600 μm or smaller than 200 μm. In this context, narrower particle size distributions are further preferred. Particularly advantageous process variants are characterized in that the particulate premixes for compression has a particle size distribution in which more than 30% by weight, preferably more than 40% by weight, and in particular more than 50% by weight of the particles have a size of between 600 and 1000 μm.

In connection with the implementation of tableting, the process preferred in accordance with the invention is not restricted to compressing only one particulate premix to form a tablet. Rather, this step of the process may also be extended—especially when producing base tablets; see above—to the effect that, in a manner known per se, multilayer tablets are produced by preparing two or more premixes which are compressed one atop another. In this case, the first premix filled in is slightly precompressed in order to acquire a smooth top face which extends parallel to the tablet body, and, after the second premix has been filled in, final compression takes place to form the finished tablet. In the case of tablets with three or more layers there is a further precompression following the addition of each premix before the tablet, after the addition of the last premix, undergoes final compression. Preferably, the above-described cavity in the base tablet is a depression, so that preferred embodiments of the first process of the invention are characterized in that multilayer tablets having a depression are produced in a manner known per se by compressing a plurality of different particulate premixes one atop another.

The tablets are produced first of all by dry-mixing the constituents, some or all of which may have been pregranulated, and subsequently shaping the dry mixture, in particular by compression to tablets, in which context it is possible to have recourse to conventional processes. To produce the tablets of the invention, the premix is compacted in a so-called die between two punches to form a solid compact. This operation, which is referred to below for short as tableting, is divided into four sections: metering, compaction (elastic deformation), plastic deformation, and ejection.

First of all, the premix is introduced into the die, the fill level and thus the weight and form of the resulting tablet being determined by the position of the lower punch and by the form of the compression tool. Even in the case of high tablet throughputs, constant metering is preferably achieved by volumetric metering of the premix. In the subsequent course of tableting, the upper punch contacts the premix and is lowered further in the direction of the lower punch. In the course of this compaction the particles of the premix are pressed closer to one another, with a continual reduction in the void volume within the filling between the punches. When the upper punch reaches a certain position (and thus when a certain pressure is acting on the premix), plastic deformation begins, in which the particles coalesce and the tablet is formed. Depending on the physical properties of the premix, a portion of the premix particles is also crushed and at even higher pressures there is sintering of the premix. With an increasing compression rate, i.e., high throughputs, the phase of elastic deformation becomes shorter and shorter, with the result that the tablets formed may have larger or smaller voids. In the final step of tableting, the finished tablet is ejected from the die by the lower punch and conveyed away by means of downstream transport means. At this point in time, it is only the weight of the tablet which has been ultimately defined, since the compacts may still change their form and size as a result of physical processes (elastic relaxation, crystallographic effects, cooling, etc).

Tableting takes place in commercially customary tableting presses, which may in principle be equipped with single or double punches. In the latter case, pressure is built up not only using the upper punch; the lower punch as well moves toward the upper punch during the compression operation, while the upper punch presses downward. For small production volumes it is preferred to use eccentric tableting presses, in which the punch or punches is or are attached to an eccentric disk, which in turn is mounted on an axle having a defined speed of rotation. The movement of these compression punches is comparable with the way in which a customary four-stroke engine works. Compression can take place with one upper and one lower punch, or else a plurality of punches may be attached to one eccentric disk, the number of die bores being increased correspondingly. The throughputs of eccentric presses vary, depending on model, from several hundred up to a maximum of 3000 tablets per hour.

For greater throughputs, the apparatus chosen comprises rotary tableting presses, in which a relatively large number of dies is arranged in a circle on a so-called die table. Depending on model, the number of dies varies between 6 and 55, larger dies also being obtainable commercially. Each die on the die table is allocated an upper punch and a lower punch, it being possible again for the compressive pressure to be built up actively by the upper punch or lower punch only or else by both punches. The die table and the punches move around a common, vertical axis, and during rotation the punches, by means of raillike cam tracks, are brought into the positions for filling, compaction, plastic deformation, and ejection. At those sites where considerable raising or lowering of the punches is necessary (filling, compaction, ejection), these cam tracks are assisted by additional low-pressure sections, low tension rails, and discharge tracks. The die is filled by way of a rigid supply means, known as the filling shoe, which is connected to a stock vessel for the premix. The compressive pressure on the premix can be adjusted individually for upper punch and lower punch by way of the compression paths, the buildup of pressure taking place by the rolling movement of the punch shaft heads past displaceable pressure rolls.

In order to increase the throughput, rotary presses may also be provided with two filling shoes, in which case only one half-circle need be traveled to produce one tablet. For the production of two-layer and multilayer tablets, a plurality of filling shoes are arranged in series, and the gently pressed first layer is not ejected before further filling. By means of an appropriate process regime it is possible in this way to produce laminated tablets and inlay tablets as well, having a construction like that of an onion skin, where in the case of the inlay tablets the top face of the core or of the core layers is not covered and therefore remains visible. Rotary tableting presses can also be equipped with single or multiple tools, so that, for example, an outer circle with 50 bores and an inner circle with 35 bores can be used simultaneously for compression. The throughputs of modern rotary tableting presses amount to more than a million tablets per hour.

When tableting with rotary presses it has been found advantageous to perform tableting with minimal fluctuations in tablet weight. Fluctuations in tablet hardness can also be reduced in this way. Slight fluctuations in weight can be achieved as follows:

use of plastic inserts with small thickness tolerances

low rotor speed

large filling shoes

harmonization between the filling shoe wing rotary speed and the speed of the rotor

filling shoe with constant powder height

decoupling of filling shoe and powder charge

To reduce caking on the punches, all of the antiadhesion coatings known from the art are available. Polymer coatings, plastic inserts or plastic punches are particularly advantageous. Rotating punches have also been found advantageous, in which case, where possible, upper punch and lower punch should be of rotatable configuration. In the case of rotating punches, it is generally possible to do without a plastic insert. In this case the punch surfaces should be electropolished.

It has also been found that long compression times are advantageous. These times can be established using pressure rails, a plurality of pressure rolls, or low rotor speeds. Since the fluctuations in tablet hardness are caused by the fluctuations in the compressive forces, systems should be employed which limit the compressive force. In this case it is possible to use elastic punches, pneumatic compensators, or sprung elements in the force path. In addition, the pressure roll may be of sprung design.

Tableting machines suitable in the context of the present invention are obtainable, for example, from the following companies: Apparatebau Holzwarth GbR, Asperg, Wilhelm Fette GmbH, Schwarzenbek, Hofer GmbH, Weil, Horn & Noack Pharmatechnik GmbH, Worms, IMA Verpackungssysteme GmbH, Viersen, KILIAN, Cologne, KOMAGE, Kell am See, KORSCH Pressen AG, Berlin, and Romaco GmbH, Worms. Examples of further suppliers are Dr. Herbert Pete, Vienna (AU), Mapag Maschinenbau AG, Berne (CH), BWI Manesty, Liverpool (GB), I. Holland Ltd., Nottingham (GB), Courtoy N.V., Halle (BE/LU), and Mediopharm, Kamnik (SI). A particularly suitable apparatus is, for example, the hydraulic double-pressure press HPF 630 from LAEIS, D. Tableting tools are obtainable, for example, from the following companies: Adams Tablettierwerkzeuge, Dresden, Wilhelm Fett GmbH, Schwarzenbek, Klaus Hammer, Solingen, Herber & Sohne GmbH, Hamburg, Hofer GmbH, Weil, Horn & Noack, Pharmatechnik GmbH, Worms, Ritter Pharmatechnik GmbH, Hamburg, Romaco GmbH, Worms, and Notter Werkzeugbau, Tamm. Further suppliers are, for example, Senss AG, Reinach (CH) and Medicopharm, Kamnik (SI).

The tablets can be produced—as already mentioned earlier above—in predetermined three-dimensional forms and predetermined sizes. Suitable three-dimensional forms are virtually any practicable designs—i.e., for example, bar, rod or ingot form, cubes, blocks and corresponding three-dimensional elements having planar side faces, and in particular cylindrical designs with a circular or oval cross section. This latter design covers forms ranging from tablets through to compact cylinders having a height-to-diameter ratio of more than 1.

However, it is also possible for the various components not to be compressed to a homogeneous tablet, but instead to obtain tablets (especially base tablets, see above) having a plurality of layers, i.e., at least two layers. In this case it is also possible for these different layers to have different dissolution rates. This may result in advantageous performance properties for the tablets. If, for example, there are components present in the tablets which have adverse effects on each other, then it is possible to integrate one component into the quicker-dissolving layer and the other component into a slower-dissolving layer, so that the first component has already reacted when the second passes into solution. The layer structure of the tablets may be realized in stack form, in which case dissolution of the inner layer(s) at the edges of the tablet takes place at a point when the outer layers have not yet fully dissolved; alternatively, the inner layer(s) may also be completely enveloped by the respective outerlying layer(s), which prevents premature dissolution of constituents of the inner layer(s).

In one further-preferred embodiment of the invention, a tablet (especially base tablet, see above) consists of at least three layers, i.e., two outer and at least one inner layer, with at least one of the inner layers comprising a peroxy bleach, while in the stack-form tablet the two outer layers, and in the case of the envelope-form tablet the outermost layers, are free from peroxy bleach. Furthermore, it is also possible to provide spatial separation of peroxy bleach and any bleach activators and/or enzymes present in a tablet.

After compression, the detergent tablets possess high stability. The fracture strength of cylindrical tablets can be gaged by way of the parameter of diametral fracture stress. This diametral fracture stress can be determined by

$$σ = \frac{2 P}{π D t}$$

where σ represents the diametral fracture stress (DFS) in Pa, P is the force in N which leads to the pressure exerted on the tablet, which pressure causes the fracture of the tablet, D is the tablet diameter in meters, and t is the tablet height.

The second step of the process of the invention comprises the application of the coating. To this end it is possible to have recourse to common methods of coating bodies, thus in particular the immersion of the body in or the spraying of the body with a melt, solution or dispersion of the aforementioned coating materials.

Since the immersion of detergent tablets in melts or solutions or dispersions leads to the desired thin coatings only with a high level of technical effort, it is preferred in the context of the present invention to spray solutions or dispersions of said coating materials onto the tablets, with the solvent or dispersion medium evaporating and leaving a coating on the tablet. In preferred processes of the invention an aqueous solution of one or more of said coating materials is sprayed onto the tablets produced in step A), with the aqueous solution containing—based in each case on the solution—from 1 to 20% by weight, preferably from 2 to 15% by weight, and in particular from 4 to 10% by weight of one or more of said coating materials, optionally up to 20% by weight, preferably up to 10% by weight, and in particular below 5% by weight of one or more water-miscible solvents, and water as the remainder.

In order to shorten the drying time it is possible to admix further water-miscible, highly volatile solvents to the aqueous solution. These solvents come in particular from the group of the alcohols, preference being given to ethanol, n-propanol, and iso-propanol. On grounds of cost, ethanol and iso-propanol are particularly recommended.

Coating from water-free or low-water-content solutions may also be advantageous in the case of certain coating materials.

As already mentioned earlier on above, for certain functional coatings an “undercoating” may be preferable in order to enhance the adhesion of the coating. Protection of the functional coating by a further “overcoating” may also produce advantages where appropriate. For these reasons, preference is given to processes of the invention wherein the coating in step B) comprises the application of one or more, preferably two or three, coating layers.

As already mentioned, functional coatings with temperature-inverse dissolution characteristics are particularly preferred (see above). Accordingly, preference is also given to processes wherein the body produced in step A) is coated in step B) with an LCST polymer.

The composition with which the coated second part is formulated to give the detergent of the invention can adopt any physical form whatsoever, as set out in detail earlier on above. In a sequence of ascending preference, preference is given to processes of the invention wherein the composition in step C) is a liquid, gellike or pastelike composition. Particular preference is given to processes wherein the composition in step C) is a particulate composition. And particular preference is given to processes of the invention which are characterized in that the composition in step C) is a tablet-form composition, details on tableting and on preferred embodiments of the “base tablets” being located earlier on above.

It has already been mentioned that in particular an embodiment wherein the base tablet comprises one or more cavities of which at least one contains the coated second part are preferred. Accordingly, preference is also given to processes wherein the composition in step C) is a multiphase detergent tablet which has a cavity into which the coated body from step B) is bonded adhesively or pressed.

In these preferred processes the second part may adhere to the first part solely by virtue of the shape; however, it is preferred, on account of better transit and handling stability, to either press or adhere the second part into the first part, so that it is joined to it with firm adhesion. As compared with mechanical fastening by pressing, adhesive bonding is preferred, since in this case the risk of destroying the coating of the second part is lower. In the case of insertion with adhesive bonding adhesion promoter is applied to one or more tablet surfaces. In the case of the abovementioned processes wherein two tablets are joined to one another, this may take place either in the case of the tablet with cavity or in the case of the tablet which fills the cavity. In preferred processes, adhesion promoters are introduced into the cavity of the tablet.

This procedure can be realized to particularly good effect in the case of depression tablets, since the adhesive can readily be metered by the dropwise insertion of liquid adhesion promoters into the depression. Suitable metering units for the industrial metering of small quantities of liquid into hollows are sufficiently well known to the skilled worker.

Often it is simpler, technically, to carry out the application of adhesion promoter to the tablet which fills the cavity. In such cases particular preference is given to processes which are characterized in that the adhesion promoter is applied to one or more surfaces, preferably to one surface, of the coated second part.

This application of adhesion promoter to preferably one surface of the coated second part may take place in a variety of ways. It is possible, for example, to wet one side of the coated second part with adhesive in a dipping method and then to place it in the cavity. This technique is easy to realize from a technological standpoint but harbors the risk of adhesive soiling the surface of the tablet with cavity. With this variant, the amount of adhesive can be controlled by varying the rheological properties of the adhesion promoters.

Another possibility, and one which is preferred in the context of the present invention for applying adhesion promoter to preferably one surface of the coated second part, consists in guiding this dosing unit past adhesive metering systems and then placing it into the cavity. This is done by means of adhesion-promoter-metering nozzles, adhesion-promoter-impregnated brushes or nonwoven webs, or by means of rollers. The last-mentioned process configuration is particularly simple to realize, since the coated second part has only a small area of contact with the roller. In this case the adhesion promoter can be metered from the inside of the roller, although it is also possible to apply the adhesion promoter to the roller at a point remote from the point of contact of the roller with the coated second parts. Processes wherein the application of the adhesion promoter(s) takes place to one surface of the coated second part, preferably using adhesion-promoter-transfering rollers, brushes or nonwoven webs, are thus preferred.

The filling of the cavity (the coated second part) may completely fill the cavity, or else may protrude from the cavity or only partly fill it, there being no limits on the imagination of the product developers. By varying the shape of the tablet with continuous hole or depression, the shape of the depression or of the hole, and the shape of the coated second part, it is possible to produce multivarious tablet variations which differ sharply from one another in visual terms. Thus, for example, the above-described circular annular tablet with a circular hole can be filled with a form-fitting cylinder. It is also possible, however, to use, for example, a ball, a cuboid which bears only at the edges, a three-, five- or six-sided prism, or another, irregular shape. Depending on the effort one wishes to make, it is also possible to actualize octahedral, multiply capped-prismatic or icosahedral forms for the coated second part.

In the case both of the hole tablets and of the depression tablets, the adhesion of the coated second part in the cavity falls as the area of contact goes down. Maximum adhesion between the two tablets is achieved when the annular or depression tablet and the coated second part fit into one another positively without gaps.

Completely in analogy to the above-described production of two-phase tablets by adhesively bonding two separately compressed tablets onto or into one another, it is also possible to produce three-phase tablets. In this case the adhesive bonding of three separately produced tablets either onto or into one another is appropriate, but it is also possible, and preferred, to produce a two-phase tablet—a two-layer tablet, for example—and to insert a further tablet onto or into it.

The said principle may be extended correspondingly to further multiphase detergent tablets. Thus it is possible, for example, to produce four-phase tablets by joining two two-phase tablets to one another. In analogy, four-phase 3:1 tablets can also be produced. Naturally, the two-phase tablets to be joined together can also be produced in different ways. Thus it is possible, for example, to produce a single-layer or multilayer depression tablet, to fill the depression with an active substance (for example as a melt, powder, granule, extrudate, flakes, etc.), and to apply a further one-, two- or three-phase tablet to the tablet. In this context a very wide variety of possibilities may be varied: for example, a two-layer depression tablet whose depression has been filled with a melt or with a particulate mixture, with a further tablet being applied in a firmly adhering manner to that side of the tablet which has the depression. In this way the depression becomes, so to speak, the “core”, since the filling is now present surroundingly on all sides. A completely identical procedure can be taken with a tablet which has a continuous hole (annular tablet) and then on both sides is “sealed” with a further tablet. The only matter essential to the invention with all of these embodiments is that at least one phase is a coated second part in the sense of the invention.

The aforementioned possibilities of joining or inserting tablets into one another may also be utilized to make the entire tablet or parts thereof soluble more rapidly. Where, for example, two planar tablets are bonded to one another with adhesion promoter, then under application conditions the ingress of water to the adhesive is possible only at the edges of the tablet when the latter has not yet been incipiently dissolved. Even when readily water-soluble adhesion promoters are used, it is not possible practically for the bond to be dissolved until part of the overall tablet has dissolved.

By targeted application of the adhesion promoter it is possible to overcome the aforementioned disadvantages. Thus it is possible, for example, and preferred to apply the adhesion promoter, when joining two tablets by their planar faces, not to the joining face but instead only to apply “adhesion promoter dots” to the contact edge or to the corners. In application, these dots are immediately exposed to the ingress of water, so that the two tablets part from one another more rapidly. Where two cuboid tablets are joined with one another in this way, it is not necessary to apply the adhesion promoter to all four edges. Instead, to contribute to even faster parting of the bond, adhesion promoter dots can be applied only to the four corners. For even quicker parting, individual dots of adhesion promoter can be dispensed with, so that, for example, only two diagonally opposite contact corners are provided with adhesion promoter.

To summarize: if more rapid dissolution of the tablet as a whole or of individual parts is desired, rapid surface enlargement by parting of the adhesive bond is optimal. This can be achieved or assisted by the selection of an appropriate form of the adhesive bond. In such cases the linear adhesive bonding is preferred over extensive bonding, with dot adhesive bonding being particularly preferred.

In addition, the form of the tablet parts to be joined with the adhesion promoter can also accelerate dissolution. Preference is given here to tablets which, following dissolution of the adhesion promoter bond, are as freely movable as possible with respect to one another; in other words, not annular core tablets but instead, preferably, base bodies which have “satellite tablets” on their outer faces. There are virtually no limits placed on the multiplicity of geometric design possibilities. On grounds of process economy, however, preference is given to tablets which are orthorhombic, tetragonal or cubic. Tablets with a circular outline can be bonded adhesively along their outer surface only by means of correspondingly biconcavely shaped intermediate pieces, which in turn are fairly difficult to tablet. Nevertheless, the joining of such tablets is also possible in accordance with the invention.

Following production, the detergents, especially detergent tablets, of the invention may be packed, the use of certain packaging systems having proven particularly useful since these packaging systems on the one hand increase the storage stability of the ingredients but on the other hand, in the case of tablets with cavities and an inserted second part, also, surprisingly, improve markedly the long-term adhesion of the depression filling. The present invention therefore additionally provides a combination of (a) detergent, especially detergent tablet(s), of the invention and a packaging system containing the detergent and/or detergent tablet(s), said packaging system having a moisture vapor transmission rate of from 0.1 g/m 2/day to less than 20 g/m 2/day if said packaging system is stored at 23° C. and a relative equilibrium humidity of 85%.

The packaging system of the combination of detergent or detergent tablet(s) and packaging system has, in accordance with the invention, a moisture vapor transmission rate of from 0.1 g/m²/day to less than 20 g/m²/day when said packaging system is stored at 23° C. and a relative equilibrium humidity of 85%. These temperature and humidity conditions are the test conditions specified in DIN Standard 53122, which allows minimal deviations (23±1° C., 85±2% relative humidity). The moisture vapor transmission rate of a given packaging system or material may be determined in accordance with further standard methods and is also described, for example, in ASTM Standard E-96-53T (“Test for measuring water vapor transmission of materials in sheet form”) and in TAPPI Standard T464 m-45 (“Water vapor permeability of sheet materials at high temperature and humidity”). The measurement principle of common techniques is based on the water uptake of anhydrous calcium chloride which is stored in a container in the appropriate atmosphere, the container being closed at the top face with the material to be tested. From the surface area of the container closed with the material to be tested (permeation area), the weight gain of the calcium chloride, and the exposure time, the moisture vapor transmission rate may be calculated as follows:

$$MVTR = \frac{24 \cdot 10 \; 000}{A} \cdot \frac{x}{y} [ g / {m}^{2} \text{/} 24 h ]$$

where A is the area of the material to be tested in cm², x is the weight gain of the calcium chloride in g, and y is the exposure time in h.

The relative equilibrium humidity, often referred to as “relative atmospheric humidity, is 85% at 23° C. when the moisture vapor transmission rate is measured in the context of the present invention. The ability of air to accommodate water vapor increases with temperature up to a particular maximum content, the so-called saturation content, and is specified in g/m³. For example, 1 m³ of air at 17° is saturated with 14.4 g of water vapor; at a temperature of 11°, saturation is reached with just 10 g of water vapor. The relative atmospheric humidity is the ratio, expressed as a percentage, of the actual water vapor content to the saturation content at the prevailing temperature. If, for example, air at 17° contains 12 g/m³ water vapor, then the relative atmospheric humidity (RH)=(12/14.4)·100=83%. If this air is cooled, then saturation (100% RH) is reached at what is known as the dew point (in the example: 14°), i.e., on further cooling a precipitate is formed in the form of mist (dew). The humidity is determined quantitatively using hygrometers and psychrometers.

The relative equilibrium humidity of 85% at 23° C. can be established precisely, for example, in laboratory chambers with humidity control, to +/−2% RH depending on the type of apparatus. In addition, constant and well-defined relative atmospheric humidities are formed in closed systems at a given temperature over saturated solutions of certain salts, these humidities deriving from the phase equilibrium between water partial pressure, saturated solution, and sediment.

The combinations of the invention, comprising detergent or detergent tablet(s) and packaging system, may of course in turn be packaged in secondary packaging, examples being cartons or trays, there being no need to impose further requirements on the secondary packaging.

The secondary packaging, accordingly, is possible but not necessary.

Packaging systems which are preferred in the context of the present invention have a moisture vapor transmission rate of from 0.5 g/m²/day to less than 15 g/m²/day.

Depending on the embodiment of the invention, the packaging system of the combination of the invention contains a defined amount of detergent or one or more detergent tablets. In accordance with the invention it is preferred either to design a tablet such that it comprises one application unit of the detergent, and to package this tablet individually, or to pack into one packaging unit the number of tablets which totals one application unit. In the case of an intended dose of 80 g of detergent, therefore, it is possible in accordance with the invention to produce and package individually one detergent tablet weighing 80 g, but in accordance with the invention it is also possible to package two detergent tablets each weighing 40 g into one pack in order to arrive at a combination in accordance with the invention. This principle can of course be extended, so that, in accordance with the invention, combinations may also comprise three, four, five or even more detergent tablets in one packaging unit. Of course, two or more tablets in a pack may have different compositions. In this way it is possible to separate certain components spatially from one another in order, for example, to avoid stability problems.

The packaging system of the combination of the invention may consist of a very wide variety of materials and may adopt any desired external forms. For reasons of economy and of greater ease of processing, however, preference is given to packaging systems in which the packaging material has a low weight, is easy to process, and is inexpensive. In combinations which are preferred in accordance with the invention, the packaging system consists of a bag or pouch of single-layer or laminated paper and/or polymer film.

The detergent tablets may be filled unsorted, i.e., as a loose heap, into a pouch made of said materials. On esthetic grounds and for the purpose of sorting the combinations into secondary packaging, however, it is preferred to fill the detergent tablets individually, or sorted into groups of two or more, into bags or pouches. For individual application units of the detergent tablets which are located in a bag or pouch, a term which has become established in the art is that of the “flow pack”. Flow packs of this kind may optionally then—again, preferably sorted—be packaged into outer packaging, which underscores the compact form of the tablet.

The single-layer or laminated paper or polymer film bags or pouches preferred for use as packaging systems may be designed in a very wide variety of ways: for example, as inflated pouches without a center seam or as pouches with a center seam which are sealed by means of heat, adhesives, or adhesive tapes. Single-layer pouch and bag materials include the known papers, which may if appropriate be impregnated, and also polymer films, which may if appropriate be coextruded. Polymer films that can be used as a packaging system in the context of the present invention are specified, for example, in Hans Domininghaus, “Die Kunststoffe und ihre Eigenschaften”, 3rd edition, VDI Verlag, Dusseldorf, 1988, page 193. FIG. 111 shown therein also gives indications of the water vapor permeability of the materials mentioned.

Combinations which are particularly preferred in the context of the present invention comprise as packaging system a bag or pouch of single-layer or laminated polymer film having a thickness of from 10 to 200 μm, preferably from 20 to 100 μm, and in particular from 25 to 50 μm.

Although it is possible in addition to the abovementioned films and papers to use wax-coated papers in the form of cardboard packaging as a packaging system for the detergent tablets, it is preferred in the context of the present invention for the packaging system not to comprise any cardboard boxes made of wax-coated paper. In the context of the present invention, the term “packaging system” always relates to the primary packaging of the detergents or tablets, i.e., to the packaging whose inner face is in direct contact with the tablet surface. No requirements whatsoever are imposed on any optional secondary packaging, so that all customary materials and systems can be used in this case.

As already mentioned earlier on above, the detergents or detergent tablets of the combination of the invention comprise further ingredients of detergents in varying amounts, depending on their intended use. Independently of the intended use of the tablets, it is preferred in accordance with the invention for the detergent or the detergent tablet(s) to have a relative equilibrium humidity of less than 30% at 35° C.

The relative equilibrium humidity of the detergents or detergent tablets may be determined in accordance with common methods, the following procedure having been chosen in the context of the present investigations: a water-impermeable 1 liter vessel with a lid which has a closable opening for the introduction of samples was filled with a total of 300 g of detergent or detergent tablets and held at a constant 23° C. for 24 h in order to ensure a uniform temperature of vessel and substance. The water vapor pressure in the space above the tablets can then be determined using a hygrometer (Hygrotest 6100, Testoterm Limited, UK). The water vapor pressure is then measured every 10 minutes until two succeeding values show no deviation (equilibrium humidity). The abovementioned hygrometer permits direct display of the recorded values in % relative humidity. Likewise preferred are embodiments of the combination of the invention wherein the packaging system is of resealable configuration. Combinations wherein the packaging system has a microperforation may also be realized advantageously in accordance with the invention.

The compositions of the invention can be employed in all standard household machine dishwashers, there being no limitations in terms of program selection. The advantageous effects are obtained both in low-temperature programs such as 45° C. programs or glassware programs and in the case of 50/55° C. or 60/65° C. programs.

The present invention therefore further provides a method of cleaning kitchen- and tableware in a household machine dishwasher wherein a particulate machine dishwashing detergent of the invention is introduced in the main cleaning cycle of the machine.

Introduction in the main cleaning cycle in this case may be effected by filling the metering compartment with the powder, the powder being released into the machine by opening of the metering compartment after a preliminary cleaning cycle, where appropriate. An alternative possibility is to introduce the powder directly into the machine and in this way to release active substance already in an optional preliminary cleaning cycle. Alternatively, it is also possible to dispense with a preliminary cleaning cycle. By virtue of the compositions of the invention there is no need to dose additional rinse aid in the rinse cycle, and methods of the invention wherein the rinse cycle of the machine is carried out without the deliberate addition of further rinse aid are therefore preferred.

The term “further rinse aid” here embraces liquid commercial rinse agents which at intervals of several wash cycles have to be placed by the user in a reservoir vessel in the machine, from where they are released under program control. This deliberate addition of a rinse aid, and the second dosing step required for this purpose, at an interval of a number of wash cycles, are unnecessary through the use of the compositions of the invention.

The present invention additionally provides a process for cleaning kitchen- and tableware in a household machine dishwasher using particulate machine dishwashing detergents, comprising the steps of

a) contacting the soiled ware with an aqueous cleaning liquor comprising water and the particulate machine dishwashing detergent, the particulate machine dishwashing detergent comprising at least one coated second part in the sense of the present invention,

b) pumping off the cleaning liquor and contacting the ware with a rinse cycle.

As already mentioned, the advantages of the present invention are also achieved when the main cleaning cycle and the rinse cycle are interrupted by intermediate wash cycles. Preferred processes are therefore characterized in that between steps a) and b) there are one or more intermediate wash cycles.

Here again, the additional deliberate metering of commercial rinse agents is unnecessary, so that processes are preferred in which in step b) no further rinse aid is deliberately added.

Said processes for the cleaning of kitchen- and tableware also make it superfluous to dose additional regenerating salt after a number of cleaning cycles. Naturally, the cleaning processes are not tied to the form in which the pulverulent cleaners are supplied, so that a method of cleaning kitchen- and tableware in a household machine dishwasher, in the course of which a detergent tablet of the invention is introduced into the main cleaning cycle of the machine, is also an embodiment of the present invention.

The present invention also further provides not least a process for cleaning kitchen- and tableware in a household machine dishwasher using one or more detergent tablets, comprising the steps of

a) contacting the soiled ware with an aqueous cleaning liquor comprising water and the detergent tablet(s), the detergent tablet(s) comprising at least one coated second part in the sense of the present invention,

b) pumping off the cleaning liquor and contacting the ware with a rinse cycle.

1. A detergent for machine dishwashing, comprising
a) a first part (base composition), which exerts its effect substantially in the main wash cycle of the dishwasher; and
b) a second part, which by dint of appropriate coating develops its effect substantially in the rinse cycle of the dishwasher,
characterized in that the second part comprises one or more substances selected from the group consisting of builders, acidifiers, chelating agents, and scale inhibiting polymers.

2. The detergent of claim 1, characterized in that the second part contains one or more builders from the group consisting of sodium carbonate, sodium hydrogen carbonate, and trisodium citrate in amounts above 10% by weight, preferably above 15% by weight, with particular preference above 20% by weight, and in particular above 25% by weight, based in each case on the weight of the second part.

3. The detergent of one of claims 1 or 2, characterized in that the second part contains one or more acidifiers from the group consisting of citric acid, adipic acid, malic acid, fumaric acid, maleic acid, malonic acid, oxalic acid, succinic acid, and tartaric acid in amounts above 5% by weight, preferably above 10% by weight, with particular preference above 20% by weight, and in particular above 25% by weight, based in each case on the weight of the second part.

4. The detergent of one of claims 1 to 3, characterized in that the second part contains one or more chelating agents from the groups consisting of
(i) polycarboxylic acids wherein the sum of the carboxyl and any hydroxyl groups is at least 5,
(ii) nitrogen-containing monocarboxylic or poly-carboxylic acids,
(iii) geminal diphosphonic acids,
(iv) aminophosphonic acids,
(v) phosphonopolycarboxylic acids, and
(vi) cyclodextrins
in amounts above 0.1% by weight, preferably above 0.5% by weight, with particular preference above 1% by weight, and in particular above 2.5% by weight, based in each case on the weight of the second part.

5. The detergent of one of claims 1 to 4, characterized in that the second part contains one or more scale inhibiting polymers from the group consisting of cationic homopolymers or copolymers, especially hydroxypropyltrimethylammonium-guar; copolymers of aminoethyl methacrylate and acrylamide, copolymers of dimethyldiallylammonium chloride and acrylamide, polymers containing imino groups, polymers containing quaternized ammonium-alkyl methacrylate groups as monomer units, cationic polymers of monomers such as trialkylammonium-alkyl (meth)acrylate or -acrylamide; dialkyldiallyldiammonium salts; polymer-analogous reaction products of ethers or esters of polysaccharides with ammonium side groups, especially guar derivatives, cellulose derivatives, and starch derivatives; polyadducts of ethylene oxide with ammonium groups; quaternary ethyleneimine polymers and polyesters and polyamides having quaternary side groups in amounts above 5% by weight, preferably above 10% by weight, with particular preference above 20% by weight, and in particular above 25% by weight, based in each case on the weight of the second part.

6. The detergent of one of claims 1 to 5, characterized in that the second part contains one or more copolymers of
i) unsaturated carboxylic acids
ii) monomers containing sulfonic acid groups
iii) if desired, further ionic or nonionogenic monomers
in amounts above 5% by weight, preferably above 10% by weight, with particular preference above 20% by weight, and in particular above 25% by weight, based in each case on the weight of the second part.

7. The detergent of one of claims 1 to 6, characterized in that the second part further contains from 1 to 50% by weight, preferably from 2.5 to 45% by weight, and in particular from 5 to 40% by weight of nonionic surfactant(s).

8. The detergent of one of claims 1 to 7, characterized in that the coating of the second part comprises an LCST polymer.

9. The detergent of claim 8, characterized in that the LCST polymer is selected from cellulose derivatives, mono- or di-N-alkylated acrylamides, copolymers of mono- or di-N-substituted acrylamides with acrylamides and/or acrylates or acrylic acids.

10. The detergent of one of claims 8 or 9, characterized in that the LCST polymer is selected from cellulose ethers, polyisopropylacrylamide, copolymers of polyisopropylacrylamide, and blends of these substances.

11. The detergent of one of claims 8 to 10, characterized in that the lower critical separation temperature of the LCST polymer lies between 20° C. and 90° C.

12. The detergent of one of claims 1 to 11, characterized in that the coating of the second part is composed of two or more coating layers, preferably of two or three coating layers.

13. The detergent of one of claims 1 to 12, characterized in that the second part has been produced by a pressing operation, especially tableting.

14. The detergent of one of claims 1 to 13, characterized in that the second part has a diameter of between 1 and 30 mm, preferably between 2.5 and 15 mm, and in particular between 5 and 10 mm.

15. The detergent of one of claims 1 to 14, characterized in that the first part contains builders in amounts of from 1 to 100% by weight, preferably from 5 to 95% by weight, with particular preference from 10 to 90% by weight, and in particular from 20 to 85% by weight, based in each case on the weight of the first part.

16. The detergent of one of claims 1 to 15, characterized in that the first part contains phosphate(s), preferably alkali metal phosphate(s), with particular preference pentasodium and/or pentapotassium triphosphate (sodium or potassium tripolyphosphate), in amounts of from 20 to 80% by weight, preferably from 25 to 75% by weight, and in particular from 30 to 70% by weight, based in each case on the weight of the first part.

17. The detergent of one of claims 1 to 16, characterized in that the first part contains citrate(s), preferably sodium citrate, with particular preference trisodium citrate dihydrate, in amounts of from 10 to 60% by weight, preferably from 15 to 50% by weight, and in particular from 20 to 40% by weight, based in each case on the weight of the first part.

18. The detergent of one of claims 1 to 17, characterized in that the first part contains bleaches from the group of the oxygen or halogen bleaches, in particular the chlorine bleaches, with particular preference sodium perborate and sodium percarbonate, in amounts of from 2 to 25% by weight, preferably from 5 to 20% by weight, and in particular from 10 to 15% by weight, based in each case on the weight of the first part.

19. The detergent of one of claims 1 to 18, characterized in that the first part contains bleach activators from the groups of polyacylated alkylenediamines, especially tetraacetylethylene-diamine (TAED), N-acyl imides, especially N-nonanoylsuccinimide (NOSI), acylated phenolsulfonates, especially n-nonanoyl- or isononanoyloxybenzenesulfonate (n- or iso-NOBS), and n-methylmorpholiniumacetonitrile methyl sulfate (MMA), in amounts of from 0.25 to 15% by weight, preferably from 0.5 to 10% by weight, and in particular from 1 to 5% by weight, based in each case on the weight of the first part.

20. The detergent of one of claims 1 to 19, characterized in that the first part contains silver protectants from the group consisting of triazoles, benzotriazoles, bisbenzotriazoles, aminotriazoles, alkylaminotriazoles, and transition metal salts or transition metal complexes, with particular preference benzotriazole and/or alkylaminotriazole, in amounts of from 0.01 to 5% by weight, preferably from 0.05 to 4% by weight, and in particular from 0.5 to 3% by weight, based in each case on the weight of the first part.

21. The detergent of one of claims 1 to 20, characterized in that the first part further contains one or more substances from the groups of enzymes, corrosion inhibitors, scale inhibitors, cobuilders, dyes and/or fragrances in total amounts of from 6 to 30% by weight, preferably from 7.5 to 25% by weight, and in particular from 10 to 20% by weight, based in each case on the weight of the first part.

22. The detergent of one of claims 1 to 21, characterized in that the first part is a liquid, gellike or pastelike composition for machine dishwashing.

23. The detergent of one of claims 1 to 21, characterized in that the first part is a particulate composition for machine dishwashing.

24. The detergent of one of claims 1 to 21, characterized in that the first part is a tablet-form composition for machine dishwashing.

25. The detergent of claim 24, characterized in that the first part is a multiphase tablet, in particular a two-, three- or four-phase tablet, it being preferred for the phases to have the form of layers.

26. The detergent of one of claims 24 or 25, characterized in that the coated second part has the form of a further layer, of a core, or of a body bonded adhesively on or in the first part (“basic tablet”).

27. The detergent of one of claims 24 to 26, characterized in that the first part has (a) cavity(ies) containing the second and any further parts.

28. The detergent of claim 27, characterized in that first part has at least two cavities one of which contains the second part while the other contains a further, functionalized part.

29. The detergent of one of claims 1 to 28, characterized in that the nonionic surfactant content of the first part is from 5 to 25% by weight, based in each case on the first part.

30. The detergent of one of claims 24 to 28, characterized in that the first part or at least one phase of a multiphase first part has a nonionic surfactant content of between 5 and 25% by weight, based in each case on the first part or on the phase of the first part.

31. A process for producing detergents for machine dishwashing, characterized by the steps of
A) producing a body which comprises one or more substances from the group consisting of builders, acidifiers, chelating agents or scale inhibiting polymers,
B) coating the body produced in step A),
C) unifying the coated body with a composition which develops its effect substantially in the main cleaning cycle of the dishwasher.

32. The process of claim 31, characterized in that the producing in step A) takes place by tableting.

33. The process of one of claims 31 or 32, characterized in that the coating in step B) comprises the application of one or more, preferably two or three, coating layers.

34. The process of one of claims 31 to 33, characterized in that the body produced in step A) is coated in step B) with an LCST polymer.

35. The process of one of claims 31 to 34, characterized in that the composition in step C) is a liquid, gellike or pastelike composition.

36. The process of one of claims 31 to 34, characterized in that the composition in step C) is a particulate composition.

37. The process of one of claims 31 to 34, characterized in that the composition in step C) is a tablet-form composition.

38. The process of claim 37, characterized in that the composition in step C) is a multiphase detergent tablet which has a cavity into which the coated body from step B) is adhesively bonded or pressed.
